(19) United States
(12) Patent Application Publication
(10) Pub. No.: US 2016/0109473 A1
(43) Pub. Date: Apr. 21, 2016

(54) WEB-BASED INTERACTIVE PROCESS FACILITIES AND SYSTEMS MANAGEMENT

(71) Applicant: Practichem LLC, Morrisville, NC (US)

(72) Inventor: Nicholas DeMarco, Raleigh, NC (US)

(73) Assignee: PRACTICHEM LLC, Morrisville, NC (US)

(21) Appl. No.: 14/885,992

(22) Filed: Oct. 16, 2015

Related U.S. Application Data
(60) Provisional application No. 62/064,995, filed on Oct. 16, 2014.

(51) Int. Cl. G01N 35/00; G05B 15/02

(52) U.S. Cl. CPC G01N 35/00871; G05B 15/02; G01N 35/0092

(57) ABSTRACT

Web-based interactive process facilities and systems management apparatus and methods are described, which have general applicability to industrial facilities and equipment utilized to carry out unit or sequential operations in the specific processing application. The apparatus and methods of the present disclosure have particular applicability to the management and operation of commercial high pressure liquid chromatography installations, and enable a substantial simplification of chromatography instruments to be employed in networked arrangements.

### CROSS-REFERENCE TO RELATED APPLICATION

The benefit under 35 USC 119 of U.S. Provisional Patent Application No. 62/064,995 filed Oct. 16, 2014 is hereby claimed. The disclosure of such U.S. provisional patent application is hereby incorporated herein by reference in its entirety, for all purposes.

### FIELD

The present disclosure relates to a web-based interactive process facilities and systems management apparatus and methods.

### SUMMARY

The present disclosure relates to web-based interactive process facilities and systems management apparatus and methods, which have general applicability to industrial facilities and equipment utilized to carry out unit or sequential operations in the specific processing application. The apparatus and method of the disclosure have particular utility to operation of high performance liquid chromatography equipment and facilities.

In one aspect, the disclosure relates to a web-based interactive process facilities and systems management apparatus, comprising a server computer including an interface software in electronic communication with a user interface executing on at least one user computer as a web-based application, said electronic communication including communication links configured for linkage to process equipment in a process facility for systems management thereof, wherein the apparatus is configured so that information related to the process equipment can be communicated between the interface software, at least one user interface, and process equipment, for operational planning, monitoring, and/or control of the process equipment operation by a user.

In another aspect, the disclosure relates to a method of operating process equipment, e.g., high-performance liquid chromatography equipment, in which the method comprises use of an apparatus of the present disclosure for operational planning, monitoring, and/or control of the process equipment operation.

Other aspects, features and embodiments of the disclosure will be more fully apparent from the ensuing description and appended claims.

### BRIEF DESCRIPTION OF THE DRAWINGS

FIGS. 1-29 show interface screens generated in the operation of the web-based interactive process facilities and systems management apparatus and methodology of the present disclosure, illustrating various aspects and features thereof.

### DETAILED DESCRIPTION

The present disclosure relates to web-based interactive process facilities and systems management apparatus and methods.

The web-based interactive process facilities and systems management apparatus and methodology of the present disclosure may be constituted with a variety of modular features and capabilities, including those illustratively described hereinafter. It will be recognized that such features and capabilities may be aggregated in any of multiple combinations and permutations thereof, in specific implementations for particular applications.

Further, while the apparatus and methodology of the present disclosure will be understood to have generalized applicability to a variety of unit operations, facilities, and processes, including manufacturing, packaging, quality assurance, diagnostics, data mining, and numerous other applications, the functional and operational character of the apparatus and methodology of the disclosure will be illustratively discussed hereinafter in reference to process facilities and system management of high performance liquid chromatography (HPLC) facilities and systems.

Components of the web-based user interface are now described, and the web-based process facilities and system management software employed to implement such interface may embody and effectuate a selected one or ones of the following modules in its overall architecture.

Status Tiles

Status tiles may be embodied in the interface, and be user-selectable for display or access of sub-functions of the specific tile. For such purposes, the tile may constitute an array (e.g., in the format of a strip, multiple strips, or a collection of same) embodying an information-rich display that communicates information about an aspect or summarized multiple aspects of an instrument or a process.

The status tiles are integrated in the display so that a user can selectively add and remove tiles, optionally with animational operations such as flip, sliding, window shade, fade and other selective operations to configure specific elements in the visualized tiles as display units of the interface.

The tiles are configured to be user-interactive in character, so that a touch or click of the tile can alter the tile view, initiate an operational mode of an instrument or process system, toggle between operational modes (e.g., between pause and resume modes) or pause an operational sequence, and/or reset an operational mode or status of an instrument or process system (e.g., to reflect emptying of a bottle or the vessel).

Tiles may be configured to numerically indicate quantities, as well as to depict them graphically and/or pictorially as spaceovisual constructs. Such quantitation may be depicted using graphic forms such as bar graphs, pie charts, background fills of grids or geometric shapes, numeric displays, and the like. Alternatively, concurrently, or independently, tiles may depict status or conditions by suitable output indicators, such as simulated LEDs or other light sources, background colors, iconographs, font effects (e.g., bold, underline, strikethrough, superscripts, subscripts, italics, etc.), graphic effects (e.g., color, vector styles such as line weight, coloration, dashing or segmentation of lines, etc.). Tiles may utilize titles or other common formative elements such as headings, frames, frame elements, background colors, status elements such as flip status, view displayed indications, etc. to communicate information. Tiles may also incorporate alert or warning outputs, such as red textual coloration to indicate error or an incipient hazard event.

The web-based interface may incorporate any of numerous designs, devices, modalities, or motifs for data visualization, as in the following illustrative example.

Data Visualization (Example: Chromatogram)

This example is directed to the monitoring and control of HPLC system operations of an HPLC facility.

To initiate the monitoring sequence, user selection of x-axis units and their resulting scale is effected by single interaction touch of a touchscreen or click of a mouse.

The web-based system of the present disclosure includes data reduction capability as a data management tool enabling efficient data visualization. Such capability reflects the fact that the collection of all data representing a chromatogram is both unnecessary and burdensome to the efficient visualization of chromatographic data.

An initial view of chromatographic data on the web-based interface often includes the full extent of respective independent abscissa and dependent ordinate data. The quantity of data frequently greatly exceeds the number of pixels on the display device on which the chromatographic data appear, resulting in the presence of excess data for the current view. Such excess data consumes valuable computing resources including processing time, resulting in generation of a “spinner” icon or other wait indicator on the displayed interface.

The web-based system of the present disclosure greatly minimizes this problem by resampling the complete data set and responsively generating a resampled data set that is matched to the number of pixels allocated for display. When a user alters the view in operations such as zooming and panning, the complete data set is resampled to match a new number of pixels in a new view.

The web-based system of the present disclosure also addresses other constraint factors affecting chromatogram displays, such as data retrieval time, data transmission time across a network, and data visualization time on a user interface.

To resolve data retrieval time constraints, and avoid excessively long retrieval times when the system retrieves data from a database, the system caches data in memory.

To resolve constraints of data transmission time across a network, in which data transmission time is largely determined by the number of data ports, the system dynamically reduces the data by identifying the most important points to transmit, as discussed more fully hereinafter.

To resolve the constraints related to data visualization time on user interfaces, which is largely determined by the number of data points to be displayed, the system dynamically determines the most important points for display by identifying data that embody the greatest change, as described hereinafter. Such maximal change approach avoids issues that would otherwise arise by sampling data at fixed intervals, which would not adequately represent a chromatogram and which would result in display of smaller than expected peaks, as well as changing the height of peaks when the user scrolls, with the result that the system displays peaks with changing heights.

When a chromatogram display is prompted by a user input, the system outputs a summary display of the chromatogram that is user-zoomable in character. As the user zooms in, the system determines which components of the data are relevant to the new view, and displays corresponding detail to the user. By the use of such approach, data transmission time is predictable and data rendering time is reasonable in duration. The system is advantageously configured so that the user can pan and zoom in real time fashion, without the occurrence of significant latency or user-interface delays.

More particularly, the system is configured so that when a user views an area of a chromatogram, the system retrieves all data between the users selected start and end positions. These selected positions may be of any suitable type, and may for example include volume, time, column volume, or other x-axis data types. For each data set, e.g., absorbance 280, conductivity, pressure, etc., the system calculates the delta change in signal between neighboring points, and then sorts the delta change in signal values from largest absolute change to smallest absolute change. The system then gathers a fixed number of data points associated with the largest delta change values, thereby limiting the number of data points, and publishes the data points to the user interface as a visualization output.

By this methodology, the system publishes a fixed number of data points, and thus consistently transmits data in a predictable amount of time. Correspondingly, since the user interface receives a fixed number of data points in populating the available pixels, the data rendering time is predictable. Further, since the system publishes a fixed number of data points to the user interface, representing the largest changes in the source data set, the user interface displays data representing the most important aspects of the source data set, enabling the user to focus on the interesting portions of the data in the visualization of the data.

When a user initiates a zooming operation, the user interface instantly zooms in to the data contained in memory, and the system then requests a higher resolution dataset.

When the server publishes detailed information about the selected zoomed-in area, the system responds with the user interface merging the zoomed-in data into the visual display, thereby allowing a user to see specific details of a region of interest, quickly in real time.

Status tiles then responsively indicate the current values of collected and processed data and/or selected point(s) or region(s). The user then interacts with the depicted status tiles to set the view properties of the corresponding data series. The view properties may for example include enabled/disabled status, color selection, scale factor, individual or collective, units for the depicted data, and the raw or refined character of the depicted data (e.g., raw/calculated or raw/smoothed as alternative depiction modes). Other status tiles may be employed that display and allow manipulation of collected data visualization views, by selection of depiction variables such as overall scale, extents, units, colors, modes (e.g., live/paused, on/off, etc.).

Panning

Views may be sequentially panned in the operation of the user interface. In this manner, the view can be smoothly advanced to follow data as presented, smoothly sliding to present selected chunks of data (e.g., fill to 90%, smoothly pan to 60%, repeat) Panning can be responsive, so that selection of a related element pans the significant data into view, optionally with highlighting of that region or selected relevant portions thereof. For example, touching a tube indicator may initiate panning of chromatographic data pertaining to the tube on the interface screen.

Zooming

Zooming operations can also be incorporated in the interface architecture, and such operations may also be responsive to specific view or user inputs. When zooming, a mini overview window can be generated to indicate that the view is zoomed in character, with the displayed sub-view being highlighted on the overview window. The large detail view can be dragged to pan, and the small sub-view can be dragged to pan the detail view. The views described by these two elements may be bidirectionally associated so that either mode can be transitioned to the other in a repetitive and reversible manner. The zoomed in window can fade away completely or partially to reveal the visualization behind. Subsequent pan or zoom activities can restore the zoomed in window to higher intensity.

Visualization Regions and Events

Regions of the interface screen may be configured to correspond to steps or events in the process. These events may be labeled with a watermark label (such as a word, or an iconograph), e.g., appearing behind the data visualization. The screen may be configured so that the label slides proportionally across the display as the display is panned. As a specific example, if a region is four screens wide, the system may be configured so that the label slides to be at a left extent when the left extent is viewed. For example, when the interface screen is employed to display quarterly calendar data, and specific quarter data, e.g., second quarter data, has panned into view, the label is centered on ¼ of the display extent. As the panning view continues, the label centers on an equivalent percentage of the display to indicate the remaining extent of the non-displayed viewport. The movement of the label in this operation is effected in a smooth and continuous manner. The displayed label may be configured to remain displayed even while panning the beginning or end of the region off the display. When a label is positioned at the start of a region and the start portion of the visualization is scrolled past the left screen boundary, the region label can remain at the extreme left screen boundary.

Events may be visualized on the interface in a manner that communicates their significance. For example, a vertical line with an optional iconograph may be utilized to indicate a noteworthy event (e.g., an error, a user action, satisfaction of a threshold criterion, etc.). Bars or strips may be utilized to indicate and correlate a region to a tube or vessel holding a material represented by the region, and tube labels may be overlaid or configured to appear in proximity to a bar or strips that indicates a specific vessel containing a particular fraction associated with the HPLC operation.

Method Programs

Method programs can be segmented into steps, and steps can be added, removed or disabled by user selection. Removed steps are configured to move to a common collection locus from which they can be returned by the user to the method program, and/or to a different method program, thereby acting as a “deep clipboard” for incorporating the removed step or steps in the different method program at a subsequent time, without loss of step data.

Step duration is shown in the title of each step along with the step name and optionally an identifying icon. Step background color may be used as a motif, to indicate a step that is in progress, or to identify an error in the step.

Gradient Editing

Some program steps may require designed changes within the step. This can be achieved graphically with a set of draggable nodes generated on the user interface. Addition and removal of nodes in this process may be effected by use of node buttons or by selecting nodes for an extended period (e.g., by a hold-to-add and/or hold-to-remove feature). Stretch handles may be employed to save users from having to manually reposition nodes coming later in the step, by shifting all later nodes when the stretch coordinates are moved.

Program steps or elements of program steps can be named, labeled or tagged with multiple tags, and “favorited” to facilitate their selection and replication in later operations. Reuse of proven elements can be employed to enhance chances of execution success.

Programs, data, elements of programs and other resources are not stored in files, but are maintained in a queryable database, with which filters and search operators can be employed to translate a user's search criteria to an importance-ordered list for user review and subsequent selection of desired resource(s).

The system is configured so that the collection of data describing a “run” or single operational sequence contains a copy of the method program employed to execute such run or operational sequence. A user thus can extract the method program, returning it to a collection of method programs that may be employed to execute future runs or operational sequences. This enables the user to avoid concern about saving a method program before a run or operational sequence is initiated. Additionally, this avoids the generation of an excessive number of method programs, since the user does not need to save derived method programs, such as those embodying minor modifications of a parent method program, until it has been demonstrated that the derived method program has value meriting its retention in the collection of method programs.

The system may also be configured so that an early step of run execution presents the user with a pre-run summary before the actual execution of the run commits the user to permanent actions. Such pre-run summary enables a user to verify that proper resources are in place to successfully execute the run, e.g., resources in the case of HPLC runs such as proper buffer(s) in sufficient quantities, proper column(s), proper rack(s), etc. The pre-run summary may also be configured to include operational parameters permitting verification that the desired run will in fact be conducted, such as overall execution time of the HPLC run, total buffer volumes consumed in the run, or other operational parameters. Mobile phase is the generic liquid chromatography term for protein chromatography's “buffer.”

At the time of the pre-run summary, the user identifies a sample by a sample identifier. The sample identifier is not required to be unique, however, the system may be configured to provide an output warning, or other indication, to the user, if the sample identifier has been used previously in the operation of the system.

The user interface system is generally configured to allow users to easily perform reversible actions, and safeguards may be incorporated against user error involving important actions, so that important and irreversible actions require additional thought steps to complete. The system may be configured so that inadvertent stoppage of a method execution can be reversed, e.g., by a system pause operation that is readily reversible with minimal consequence. The system may additionally be configured so that stopping method execution is not directly possible, but where the user must first pause method execution, with the pause actuation enabling a stop control so that the user can stop the run without additional effort, where stoppage is necessary. The system may also be safeguarded against in-process alteration, such as where a user may disable initial steps of a method, create a new step, simulate partial completion of the step that was previously being executed at the time of stoppage, and restart the modified method, by a safeguarding mechanism of generating a split data set that cannot readily be combined.

It will therefore be appreciated that the system may be configured in a wide variety of ways, to provide safe and reliable monitoring and operation of corresponding equipment and processes, and to prevent deleterious inputs and operational parameters.

Real-Time Collaboration

The web-based system of the present disclosure integrates web servers and web browsers, in an arrangement in which multiple web browsers can simultaneously connect to a single web server. This capability enables multiple users to simultaneously view and control scientific instruments in real time with insignificant delay.

Storage and Recall of Programs and Other Data

The web-based interactive process facilities and apparatus management system of the present disclosure embodies a fundamentally different approach in relation to conventional instruments and processors that heretofore have been employed in automated facilities.

Existing instruments and process equipment utilize binary files for data storage, in which the data can be or comprise method programs, elements of method programs such as steps, step elements, etc., and results. The web-based interactive process facilities and apparatus management system of the present disclosure utilizes a managed database for data storage and retrieval, in which a user queries the database with a search term for a specific type of element. As the user composes and input search term, in a character-by-character fashion, the system searches the database of elements to identify those matching the search term, with search results of the query being presented in order of likelihood of selection, with most likely elements being outputted at the top of a hierarchical ranking ranging from most likely to least likely.

Gamification

Real-Time Assistance

The web-based interactive process facilities and apparatus management system of the present disclosure in a further aspect is configured to include a real-time assistance capability. This capability is a fundamental advance over assistance operations of interactive software and systems of the prior art. The real-time assistance function of the present system reflects the increasingly collaborative character of scientific and technological endeavor, in which individual actors play roles in a larger process of design, discovery, development, etc., and in which participants must communicate effectively for the coordinated process to operate efficiently.

Prior to the development of the present system, instruments and process equipment were at best loosely connected, with files and email messages transported over a network, and many connections consisting of USB drives to move data. Although commercially available software could be loaded on a controlling PC to enable real-time chat, videoconferencing, and email operations, and screen sharing could be employed to facilitate real-time control, each of these approaches embodied separate, cumbersome solutions, none of the foregoing approaches provides a real-time, instantaneous, transparent-to-the-process capability of requesting and receiving assistance.

The approach of the present system is to enable an instrument user facing a problem to view the availability status of a potential helper. Once apprised of the availability status of the candidate helper, the user can then request assistance, such as by describing the user's issue in a chat-like format, to which the helper can agree to assist by selecting a link, to open a window into the user's instrument, following which the two parties can chat back and forth to achieve resolution of the user's issue. Such chat exchange may include any suitable medium, such as instant message, voice, video, whiteboard sharing, document sharing, etc., and a medium facilitating instrument control, such as object sharing in which data components are passed across the chat channel. The assistance system may be configured with permission features such as permission controls, to validate helper status and/or identity, so that the validated helper then can directly modify the instrument settings and/or operation, e.g., of an operating run in process involving the instrument. By such arrangement, a user is able to receive immediate assistance and progress rapidly to a solution to an issue.

Onboard Server with Integral Database

The web-based interactive process facilities and apparatus management system in various embodiments of the present disclosure includes instruments that include an onboard server computing platform. Such server includes microprocessor, RAM, persistent storage (disk, SSD, or other suitable storage apparatus and/or medium), and networking connections. The server is connected directly or indirectly to instrument components, as for example pumps, valves, liquid handlers, sensors, etc. Operating software controlling instrument logic is contained within the persistent storage or other server element(s). Instrument data, including method programs and results log files, can be stored in a same or similar persistent storage or other server element(s). Alternatively, with minimal modification to hardware and/or software, the instrument data can be “upsized” for storage on a remote data server. Such remote storage can augment, replace, or duplicate (e.g., as a backup) local storage. In various embodiments, the remote storage can comprise local storage of another, corresponding instrument.

In the case of the local storage being duplicated with remote storage, data in local and remote storage can be effectively duplicated in real time by mesh networking of the respective instruments. Mesh networking enables the data of all instruments to be available regardless of the failure of individual instruments in the mesh network so long as at least one instrument remains operationally intact. Data duplication can therefore be carried out and continued without user intervention, thus assuring that data is stored on a user's own micro-cloud of server devices.

Linking Bar

Within a method program of the present system, certain parameters will be constant for most of the method steps. In existing instrument control software, the user typically must manually link each step to a master (main) method step by including a program code.

As an example, in the use of Unicorn Control Software to control protein production workflow by an ÄKTA protein purification system (GE Biosciences AB, Uppsala, Sweden), the program code linking command is “Base: Same as main”. This code gives no indication of the main “base” and therefore the user must visit the main method step to recall the current base. This is correspondingly true of other program parameters, with linking requiring the inclusion of a command, but with the command's linked value not being displayed at the current edit point.

In the present system, this deficiency is overcome by the incorporation of linking functionality. When linked, each parameter follows the master parameter and the parameter's entry controls are removed from view. The master parameter's value may be shown in the linking control. In addition, the link state may be iconically or otherwise visually indicated in this control, e.g., by showing a sequence of continuous or broken chain links, thereby removing distracting visual clutter from the method edit panel and allowing more relevant controls to be shown, reducing the requirement to scroll off-screen.

The system is configured so that when a parameter is unlinked by a user, the parameter' s entry controls appear, taking on the value of the main method step parameter as its default value. The user may now edit this parameter value independently of the main method's similar parameter.

Quantity Editor

The web-based interactive process facilities and apparatus management system further incorporates a quantity editor, enabling quantitation selection to be achieved in a substantially simpler manner that is achievable with conventional instrumentation. In such conventional instrumentation, entry controls are typically provided for accepting quantities in the form of numeric values and units, with the units being specified for the user, and the user then entering a specific numerical value in the specified units. If the user seeks to enter a number in different units in such conventional instrumentation, such as where the system requires kilograms to be specified, but the user knows the value in pounds, then the user must convert the value without direct assistance from the instrumentation, thereby introducing additional thought and calculation to the workload of the user in the operation of the instrumentation.

The quantity editor of the present system obviates such difficulties, by accepting values in any of many reasonably likely units. Specifically, a user enters a numeric value in the numeric value portion of the quantity editor, and then enters the unit for the units portion of the editor. Although the quantity editor may be configured for first entry of a numeric value followed by entry of units for that value, the quantity editor may additionally, or alternatively, be configured for an initial entry of units followed by entry of a numeric value for such units.

In any event, upon acceptance of the specific entry, the quantity editor converts the added value to an internally represented value. The entered value is also stored and remains displayed to the user, who therefore sees the value and units originally entered in the system.

As a result of the provision of such quantity editor, a user is freed from the necessity of making minor calculations, e.g., of pounds to kilograms. In an alternative embodiment, the units can be stored in the originally entered units and subsequently converted whenever used by a particular section of the systems program code. In various other embodiments, the value may be entered in the units converted immediately upon entry, so that the quantity editor displays a preferred unit, as an override to the user's entered value and units.

The quantity editor may be configured to pop up in a specific location related to the original entry field on the interface screen, and to accommodate multiple input methods simultaneously to thereby enhance the ease and flexibility of the user's task of entry of quantitation information.

A keyboard associated with the interface display may be employed to enter numerical input. In a specific arrangement, the Enter key can accept default units or last-used units, with up and down arrows being employed to choose from a listing of units. For example, the quantity editor may be configured so that the 1st letter of each unit name can be used to select a specific unit, with subsequent presses of a same letter choosing other units with the same initial letters, e.g., wherein the an initial press of the letter “m” selecting milliliters (mL) as the volumetric units, and a second press of the letter “m” selecting minutes as the time units.

The quantity editor may be configured to calculate upper and lower range limits for each unit, such that a user entry outside valid limits initiates a screen message informing the user that correction of the entry is required. The screen message may also provide valid limits for such units, to guide the user toward an appropriate entry.

Multi-Data Stream Monitors

The web-based interactive process facilities and apparatus management system of the present disclosure may additionally comprise a multi-data stream monitoring capability.

In conventional scientific instrumentation systems, a parametric value may be measured and monitored with respect to set limits for that parameter, with the system arranged to provide an appropriate output, such as an alarm, when the monitored value exceeds one of the limits.

In contrast, the system of the present disclosure involves state-aware monitoring of parameters, so that the state of other instrument components is integrated in the monitoring of a specific parameter, to address the circumstances in which increase or decrease of a specific parameter beyond preset limits may be acceptable during particular instrument events so that unnecessary alarms or stoppages are not unnecessarily initiated.

As a specific example, fluid pressure within the system may spike during a valve switching event, and the system may accommodate such spiking events by increasing pressure alarm limits during valve change sequences. By such multi-data monitoring arrangements, system efficiency is substantially enhanced.

Performance Indicators

The web-based interactive process facilities and apparatus management system of the present disclosure in another aspect incorporates a prognostic capability to a user at the inception of a process method. This is a substantial advance over conventional instrument control systems, for which the user is presumed to understand what specific factors constitute a good method run and which factors do not.

The system of the present disclosure is configured to provide a panel of indicators to a user prior to the user's starting a run. The panel of indicators reflects the evaluations performed by the system on aspects of the method program, so that the indicators describe the likelihood of run success in the subsequent performance of the method.

The system further incorporates a retrospective run evaluation capability, being configured to generate a panel of indicators when a run has been completed and the data for that run has been compiled, showing the degree of success of the user in achieving a specific instrument performance goal.

Multi-Component Mobile Phase Mixing

In the practice of commercial chromatography, it frequently is desirable to create mixtures of multiple solutions to form a chromatographic mobile phase. It also may be desirable to vary the mobile phase composition during a chromatographic run, in order to enhance separation performance, such varying of the mixture being commonly referred to as gradient separation.

In a chromatography system comprising a single pump system, gradients may be generated by adding one or more valves, e.g., solenoid-operated valves, at the pump inlet. Such valve(s) select from multiple fluid reservoirs, directing a mobile phase component to the pump's inlet. A precise mixture of two or more components thus can be delivered by corresponding precision control and timing of each valve, so that requested concentrations can be delivered at a high level of responsive accuracy. For example, requested concentrations of 1% v/v can be consistently delivered within an accuracy of 0.5%. Even greater accuracy is possible with elimination of inconsistencies in the mobile phase in process parameters such as temperature, viscosity, and positioning.

A solenoid-operated valve is characteristically a two-position valve, in which fluid essentially flows or does not flow, depending on the open or closed state of the valve. Although partial fluid flows occurred during state transitions, such partial flows are impractical to calculate and lead to volumetric inaccuracies.

The composition of the mobile phase at the pump fluid inlet is not homogeneous, since in the operation of the pump, a bolus of one component follows a bolus of another component. Chromatographic processes perform best when the mobile phase changes are homogeneous, as opposed to an oscillatory character. Such objective of homogeneity is achieved when a mixing device aggregates multiple boluses of fluid and mixes them.

In these circumstances, a large volume mixer is more likely to be effective than a small-volume mixer, but the large-volume character of such mixer introduces undesirable delays when changing compositions. On the other hand, the use of a small-volume mixer does not entail such significant delays when changing compositions, but it increases the likelihood that the output composition will exhibit oscillations.

Accordingly, the chromatography apparatus utilized in the web-based interactive process facilities and apparatus management system of the present disclosure advantageously utilizes a variable volume mixer to achieve homogeneity of the mobile phase in the chromatographic operation.

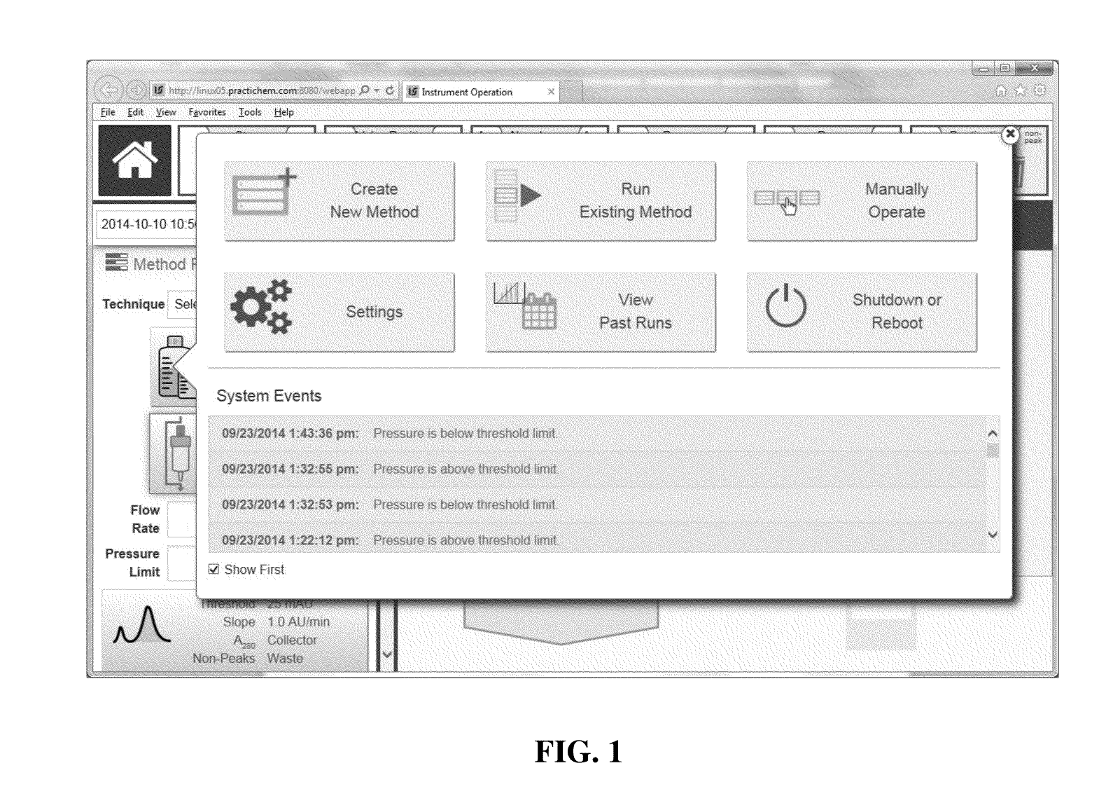

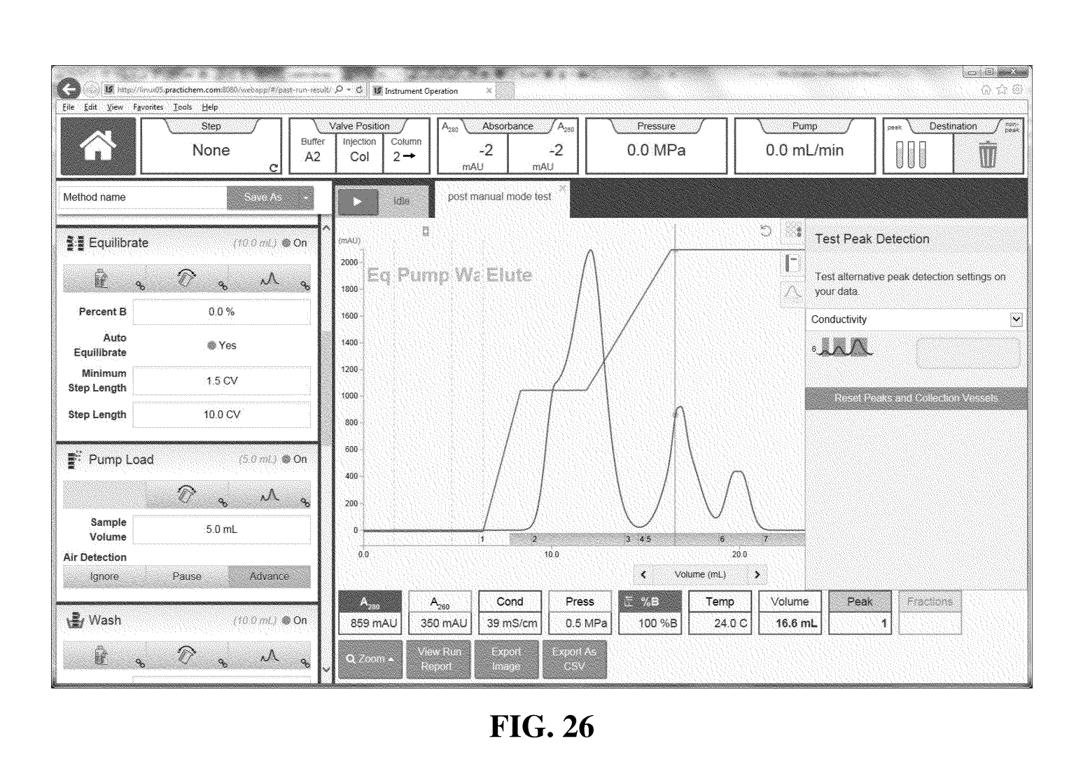

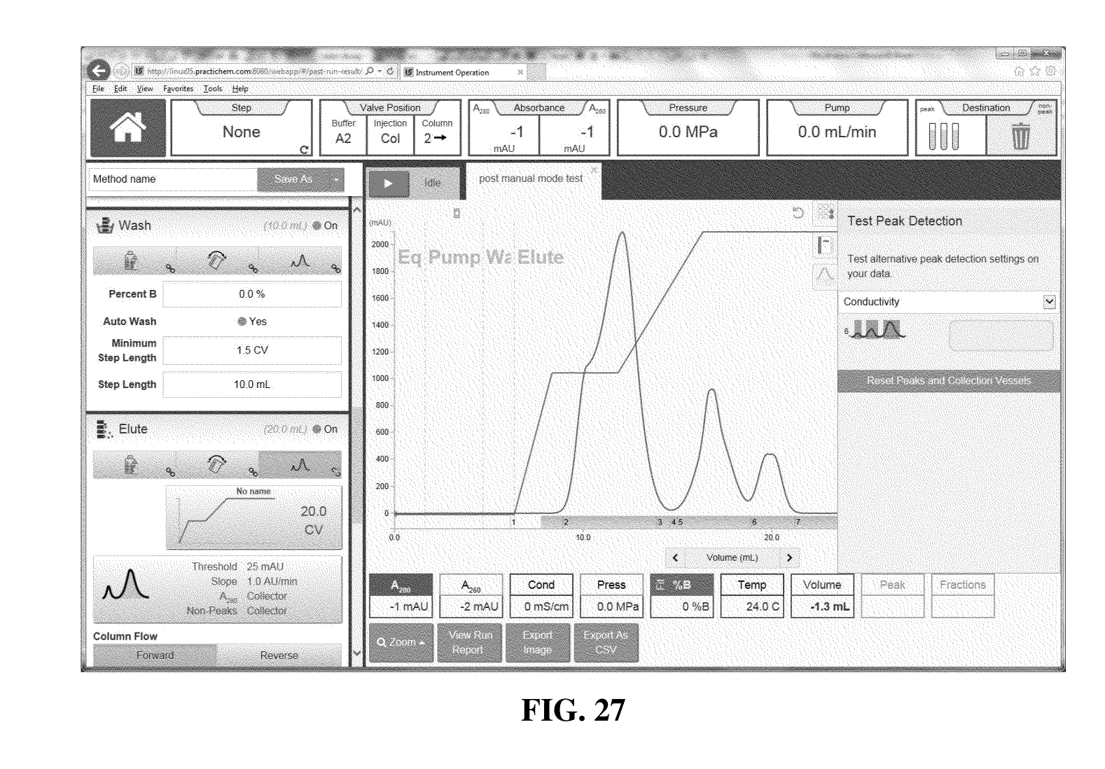

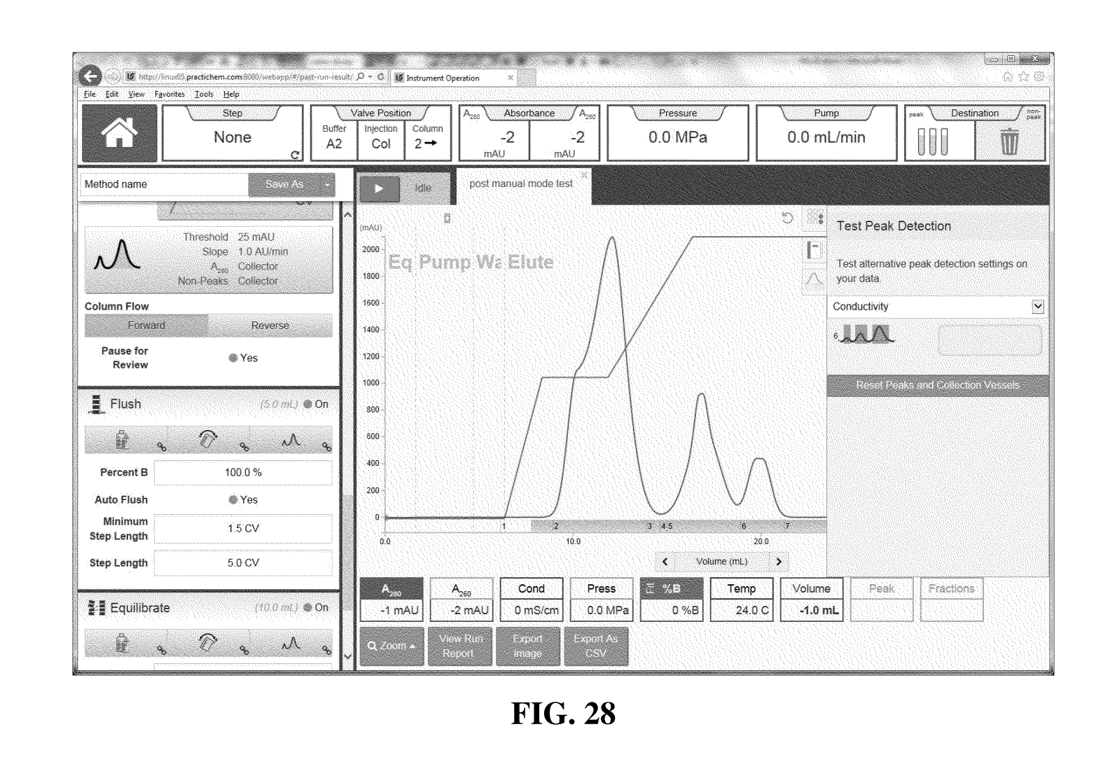

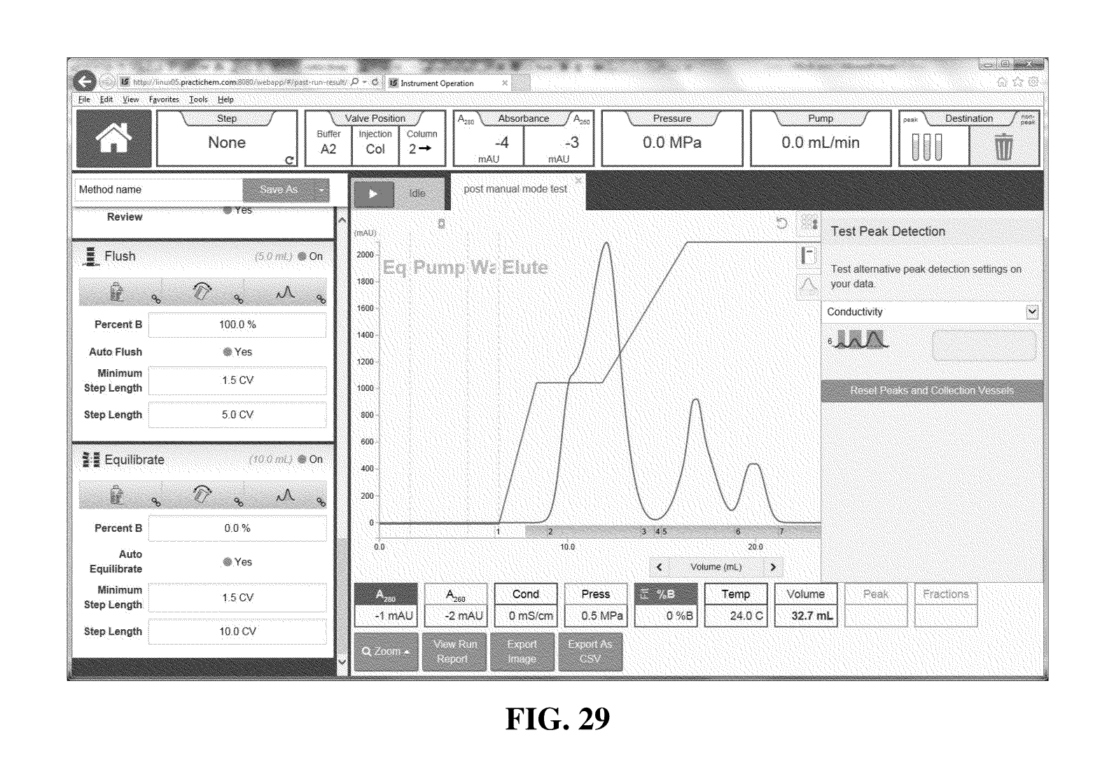

FIGS. 1-29 show interface screens generated in the operation of the web-based interactive process facilities and systems management apparatus and methodology of the present disclosure, illustrating various aspects and features thereof, in application to operation of high performance liquid chromatography instruments.

FIG. 1 is an interface screen of the home panel with event visibility that is displayed by the interactive process facilities and systems management apparatus. On this home panel interface screen, the user is able to change modes and accomplish system-level tasks. Important system events are visible here since the user must often display the home panel, and by such screen, missed system event notifications can still be seen often.

In this illustrative example, all system users would be able to view the system as having been run above allowed pressures. The excessive pressure may have damaged the instrument or caused inaccuracies in the resulting data. These events are now prominently but unobtrusively displayed to any instrument user because of the home screen event visibility.

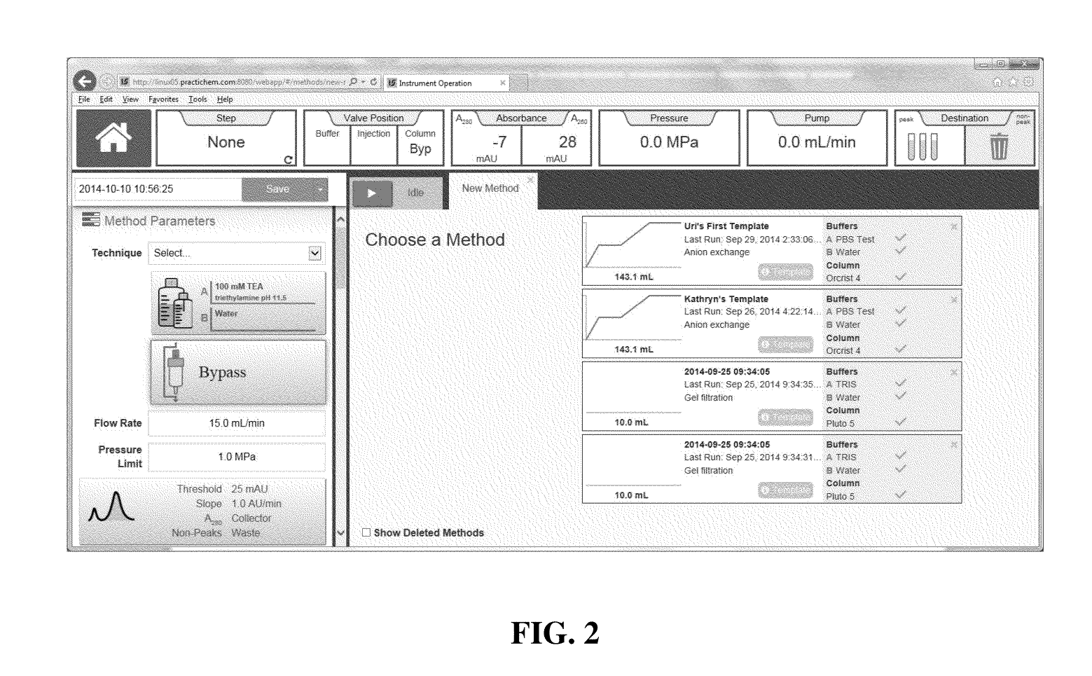

FIG. 2 is a method selection screen, in which each method is represented by a virtual card. Cards contain information about each method. The gradient profile is displayed visually here. Cards can also contain labels (sometimes called “lozenges” because they resemble the form of medicine with the same name). Method metadata appears on the cards. In the illustrated example, the card contains the resources required (buffers PBS Test and Water and the column Orcrist 4). If those resources are available on this system, check marks or similar markings indicate such availability to the user.

This is possible because method data is stored in an open, accessible way utilizing database tools. Existing solutions use binary files, where method data structures are dumped to a binary file without regard to formatting. The decoding of binary files is more difficult and more specific to versions and structures than a database because the binary file has no decoding keys. The database information stands on its own, requiring no external decoding key. Existing systems, therefore, have difficulty showing metadata about methods. In the system of the present disclosure, common web tools can search and display the metadata.

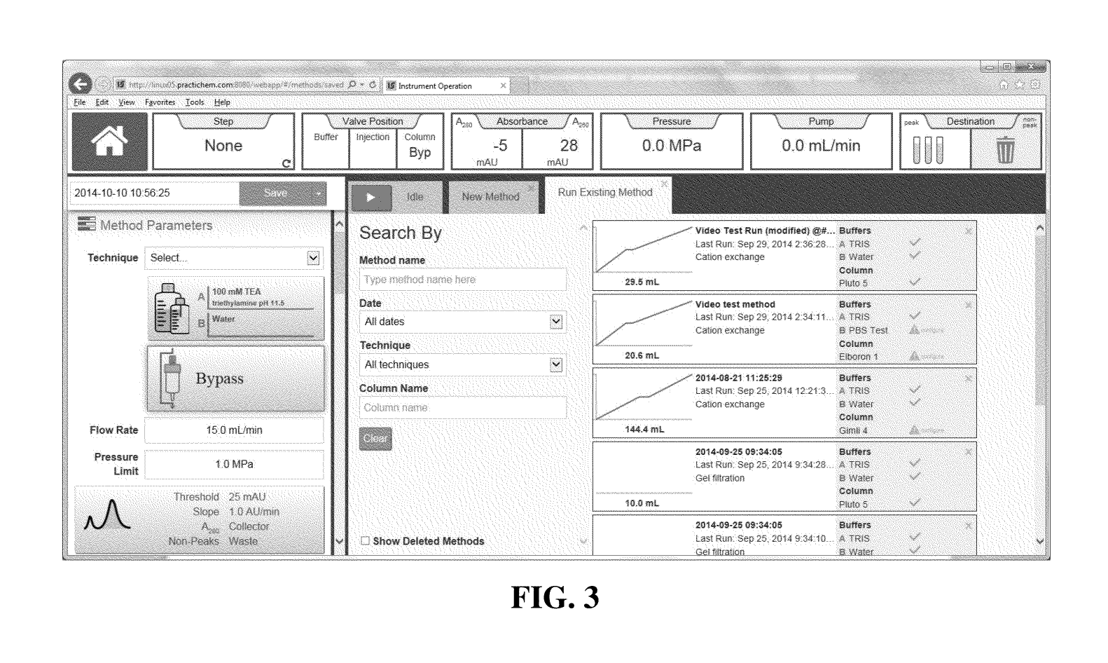

FIG. 3 is a method search screen. Compared to current alternatives using Windows file open dialogs, this search panel simplifies and speeds finding methods. Search results appear as a user types characters and selects filter criteria. The clear button reverts all search text and filters to the unrestricted state.

Deleted methods are not truly deleted. They are hidden. Selecting the “Show deleted methods” option displays these deleted methods so that they can be selected or returned to the active list. The term “deleted” may sometimes be called “hidden” instead.

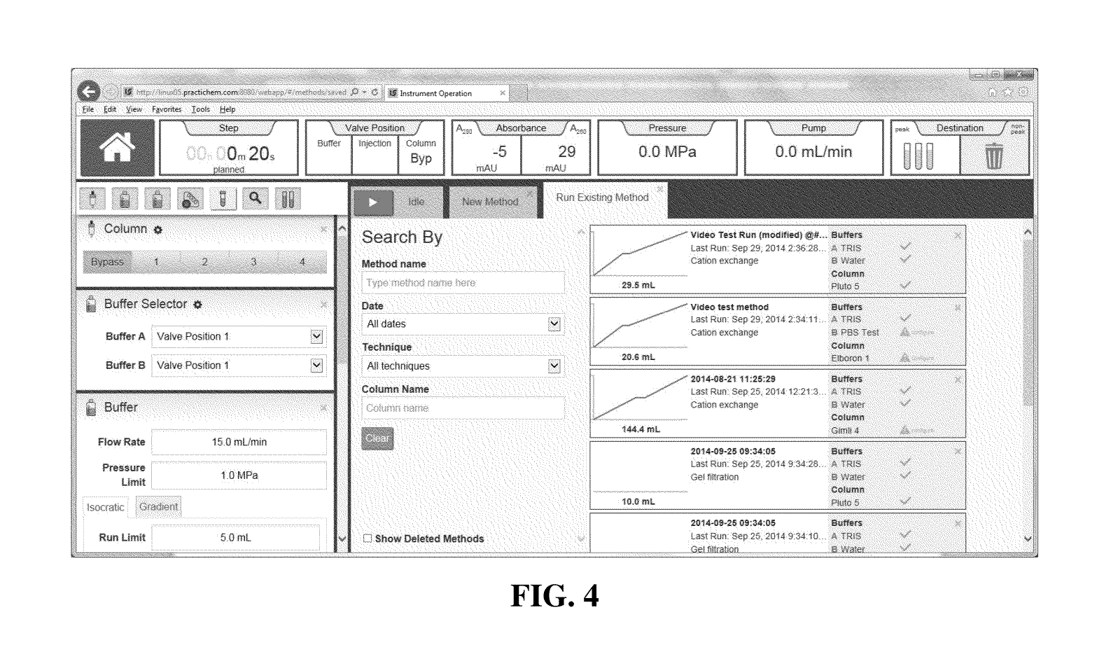

FIG. 4 is a manual control screen. The left panel shows one implementation of a manual control scheme. During routine operation, this panel can be displayed to manually override the method's automatic steps and parameters. The following controls are illustrated:

### Column Valve Control

Choose a specific column position (or the bypass position) from this control. The settings icon (gear) shows the column configuration screen.

### Buffer Selector

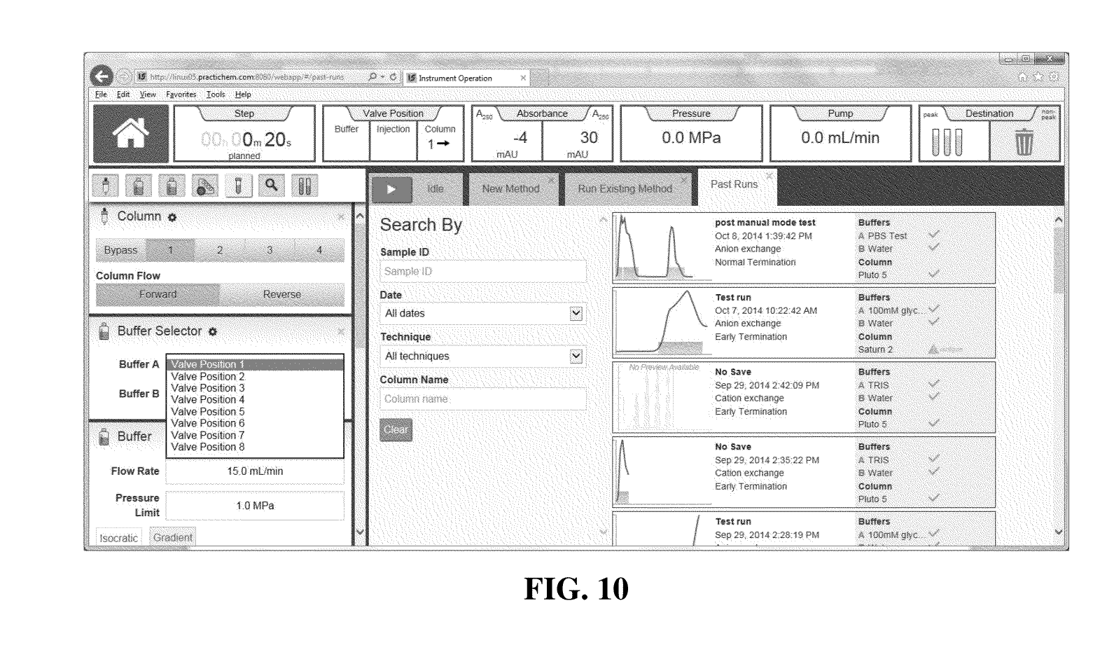

Choose the buffer valve positions for A buffer and B buffer. The settings icon (gear) shows the buffer configuration screen. See related FIG. 10.

### Buffer (Partial)

Enter parameters and control the buffer pump(s).

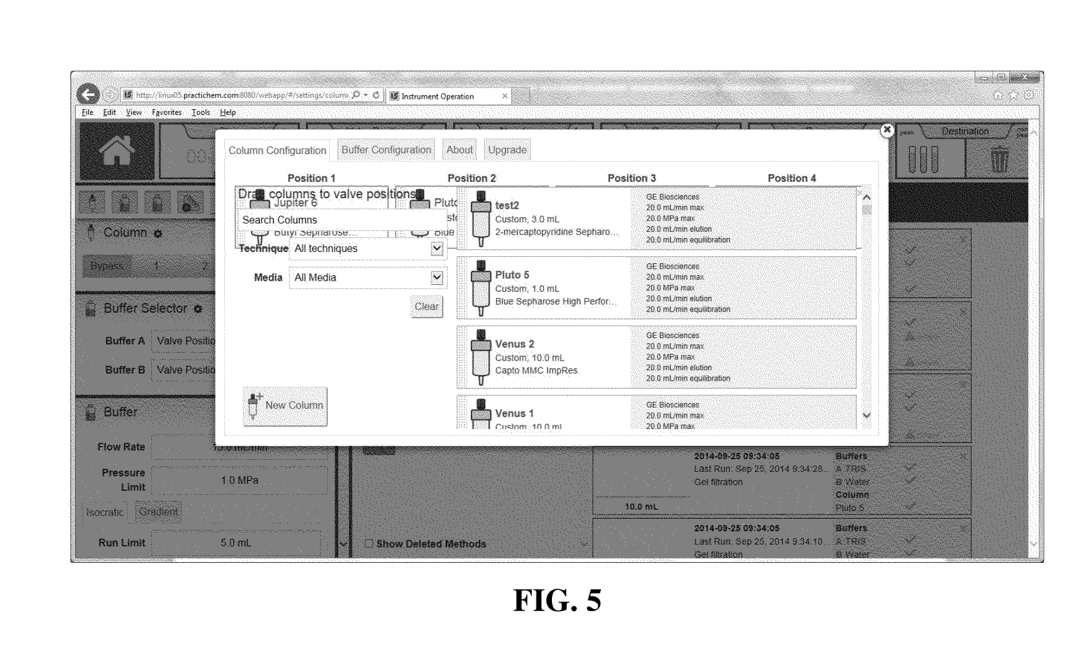

FIG. 5 is a screen showing a column to valve position assignment. In existing systems, users can only specify a valve position within a method instead of a specific buffer. This leads to confusion and potential errors. The user is not guided as to which buffer should be connected to the selected valve position. The correlation between valve position and actual buffer to use must be made outside of the method. FIG. 5 shows an implementation in which buffers are defined, then correlated to a valve position. Each buffer is represented by a virtual card. Buffer cards can be created and modified, including deletion and deactivation. Buffer cards show relevant metadata about the buffer mixtures they represent. In this way, buffer cards are similar to method cards and column cards discussed elsewhere herein.

In accordance with the present disclosure, users select one or more buffer cards from a list of known buffer cards. In the appertaining procedure, the user searches, using search and filter techniques, to find a buffer card. The user then drags the chosen card to a specific valve position. The user can vacate a valve position by choosing the ‘X’ on any position. While the user drags, the position highlights to show a possible drop target. The drop targets include an ‘X’ when populated.

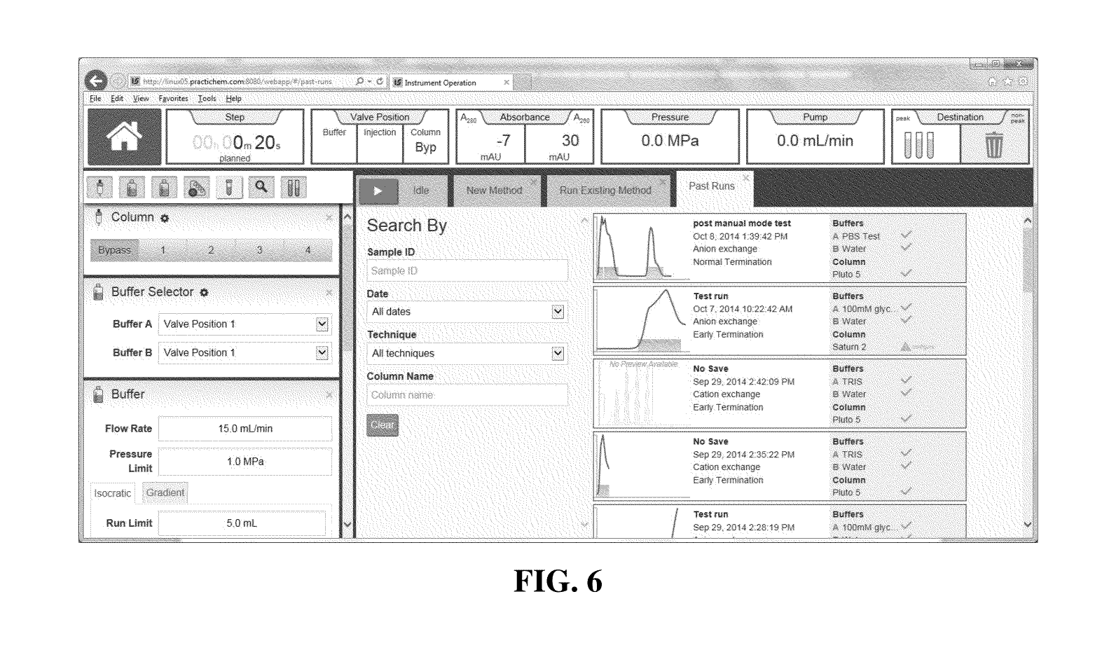

FIG. 6 is a past runs search screen. This search screen is similar to that of FIG. 3, except that the searched objects are past runs. The search process is similar. The run card metadata content is different. The displayed graphic, for example, is the chromatogram visualization. Resources used in the run are listed. Icons show if those resources are available on the current system. The manual control portion is the same as in FIG. 4.

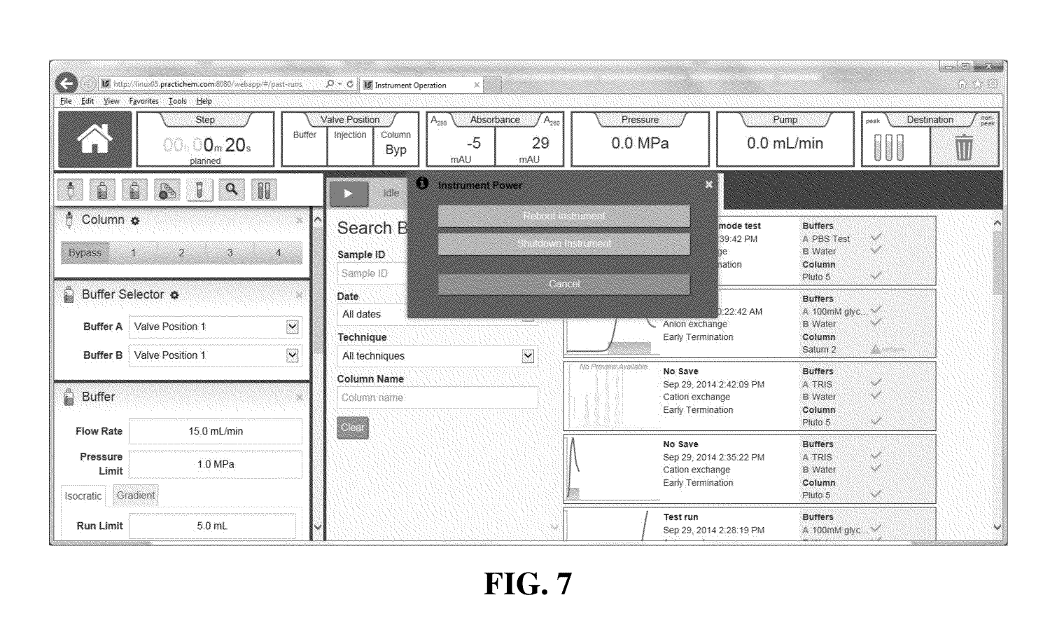

FIG. 7 is an instrument power screen, which displays displays an overlay panel to ask the user how to shut down the instrument.

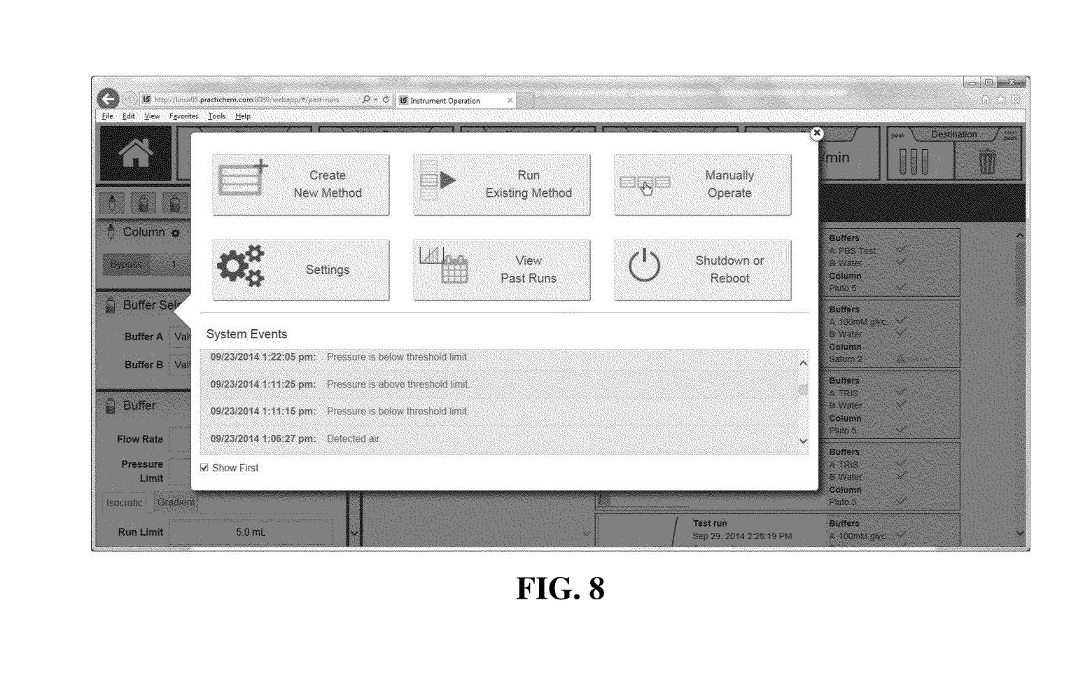

FIG. 8 shows a home menu screen. The home menu can be invoked over many things. Here, it is invoked over the instrument power panel. This home menu image also shows an additional system event, “Detected air.”

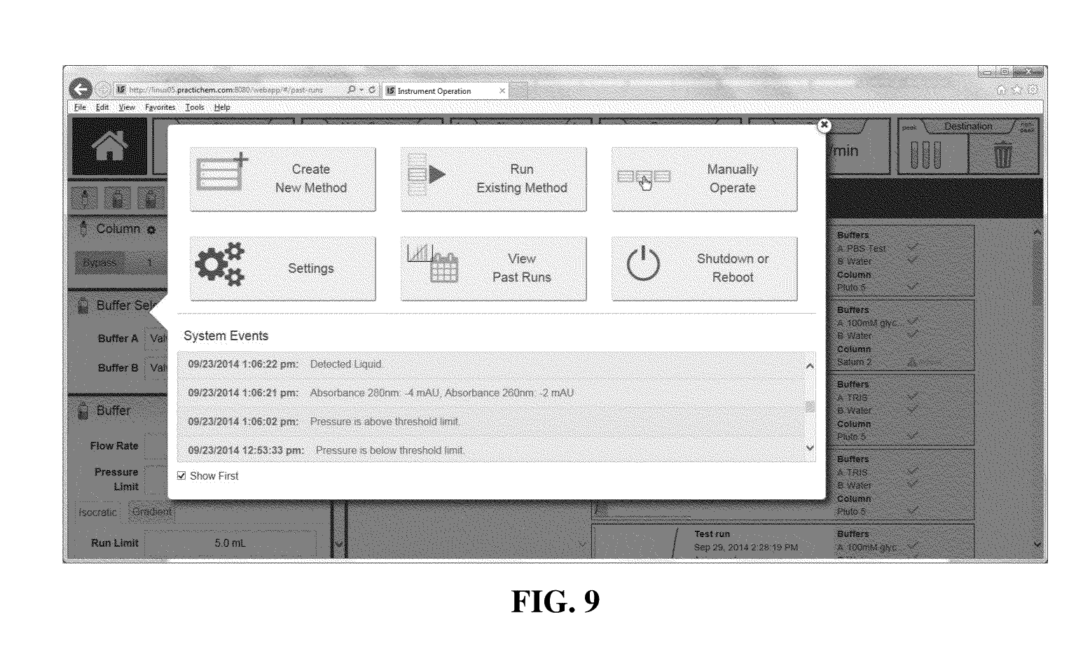

FIG. 9 is a home menu screen showing an additional system event resulting from a detector recalibration.

FIG. 10 is related to FIG. 4.

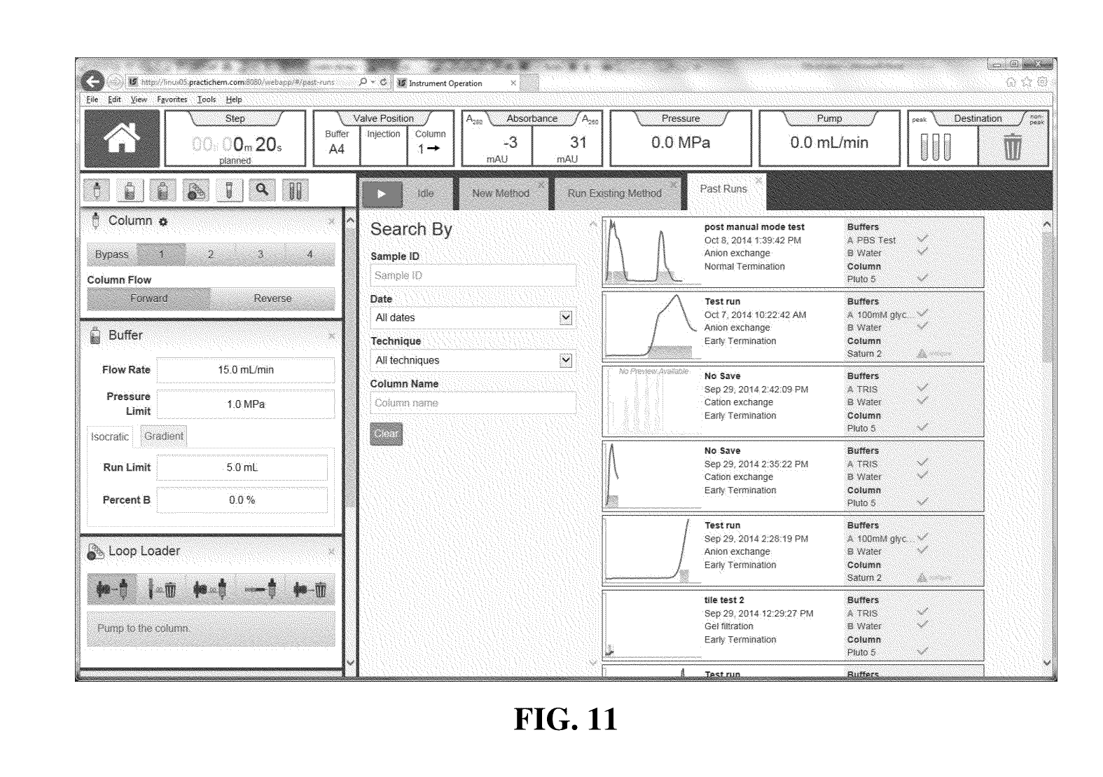

FIG. 11 likewise is related to FIG. 4 and has the following features:

### Buffer Pump Panel

The user can directly control the buffer pump system. A mix of two liquids can be specified. The mix can be static over the entire pumped volume (isocratic) or can vary with volume (gradient).

### Loop Loader

The loop loader is partially illustrated here. This valve can select among different positions for different loading options. A note describes which option has been chosen.

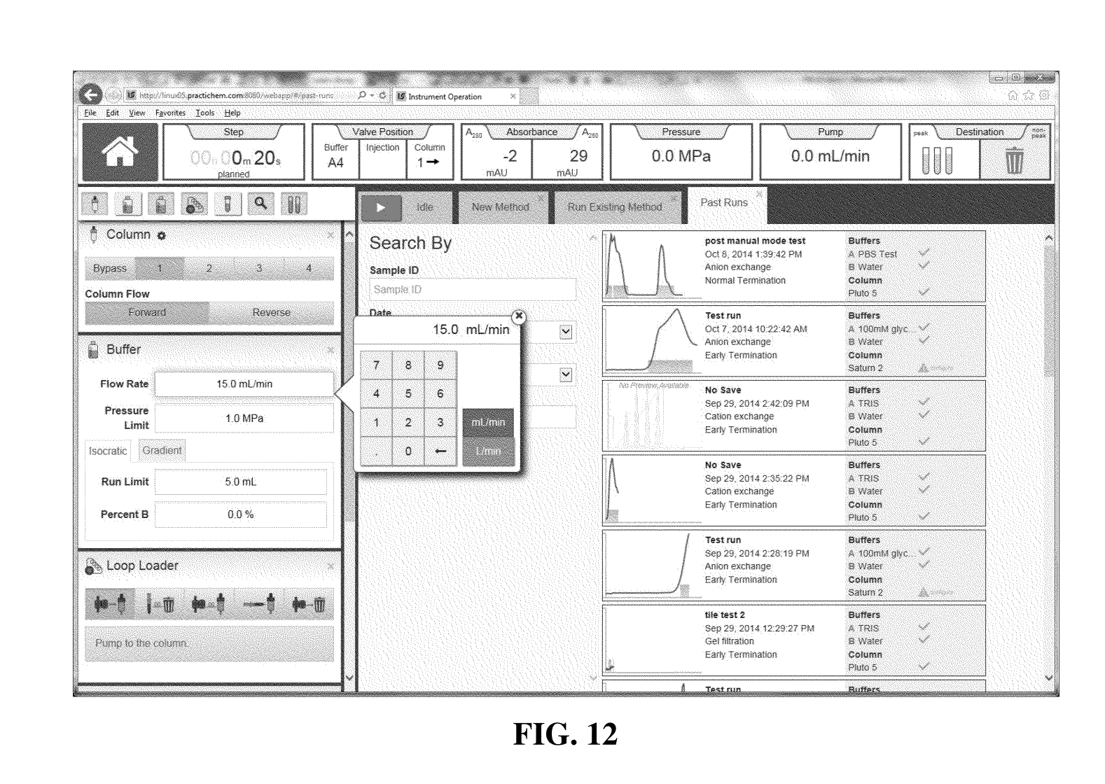

FIG. 12 is a quantity editor screen. The quantity editor enables users to enter quantities in the units most appropriate to them. Entry is via on-screen keyboard or via another input device (e.g., a physical keyboard). The unit is chosen by selecting one of the displayed unit buttons or by pressing a related key on a keyboard (e.g. m for mL/min and 1 for L/min).

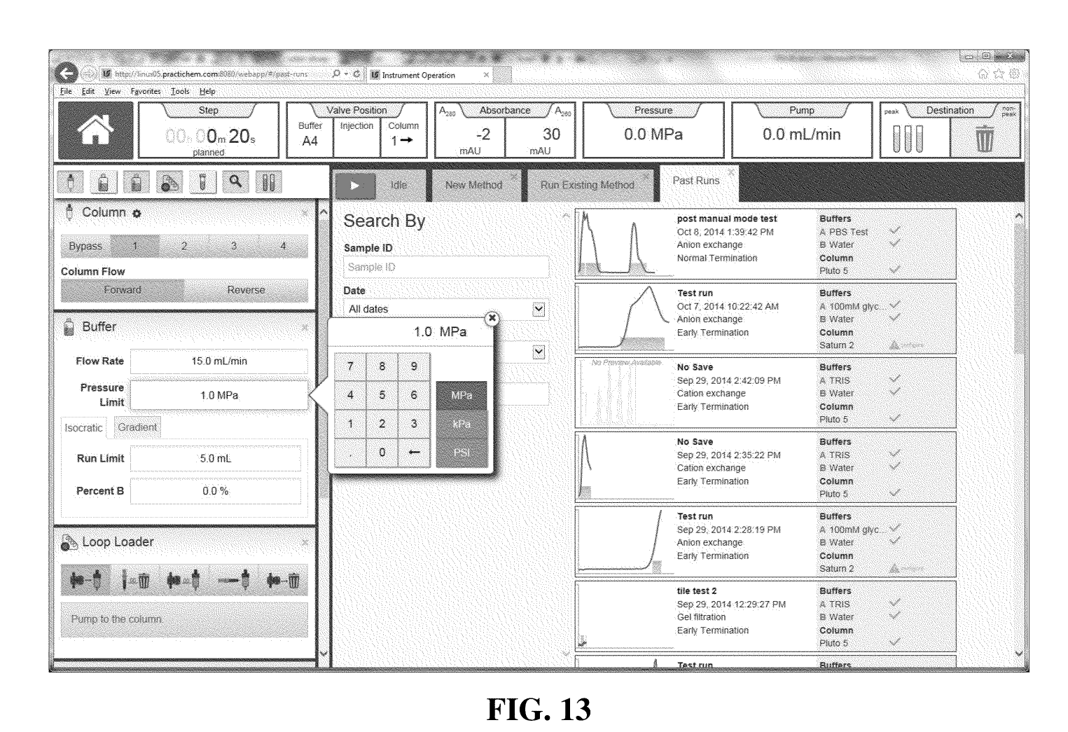

FIG. 13 is a quantity editor amplification screen. This amplifies the quantity editor description. One can see that the quantity editor works with different measurements. In this example, the user enters a pressure.

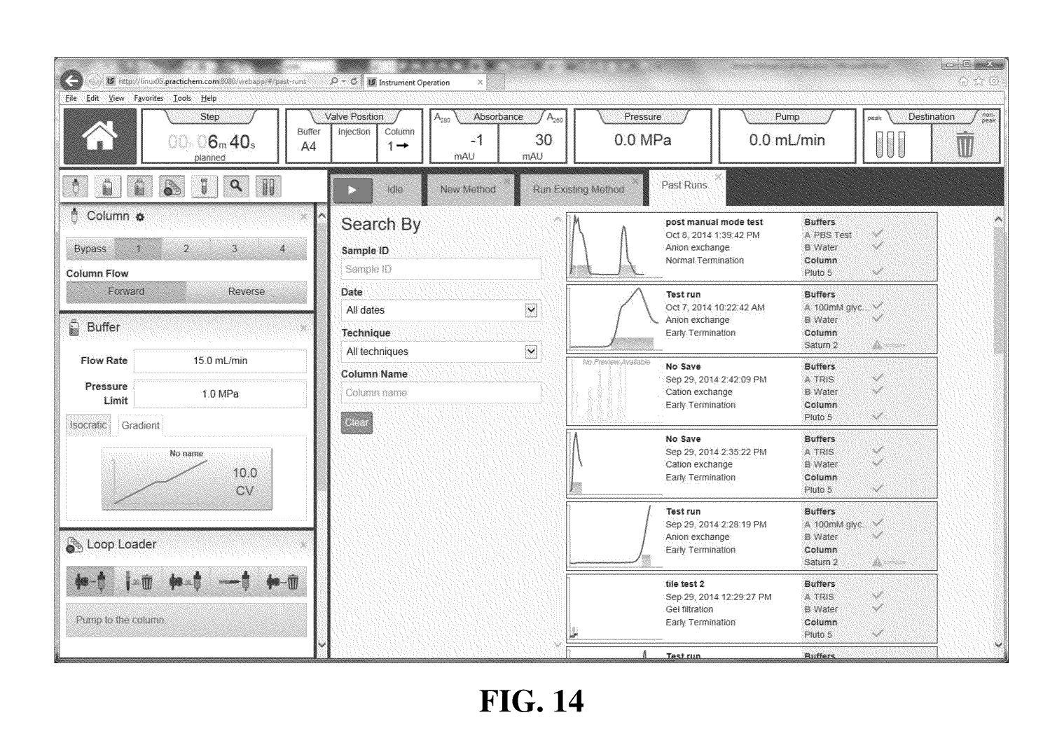

FIG. 14 is a buffer pump screen, showing the buffer pump in gradient mode. See also FIG. 11, which shows the buffer pump in isocratic mode.

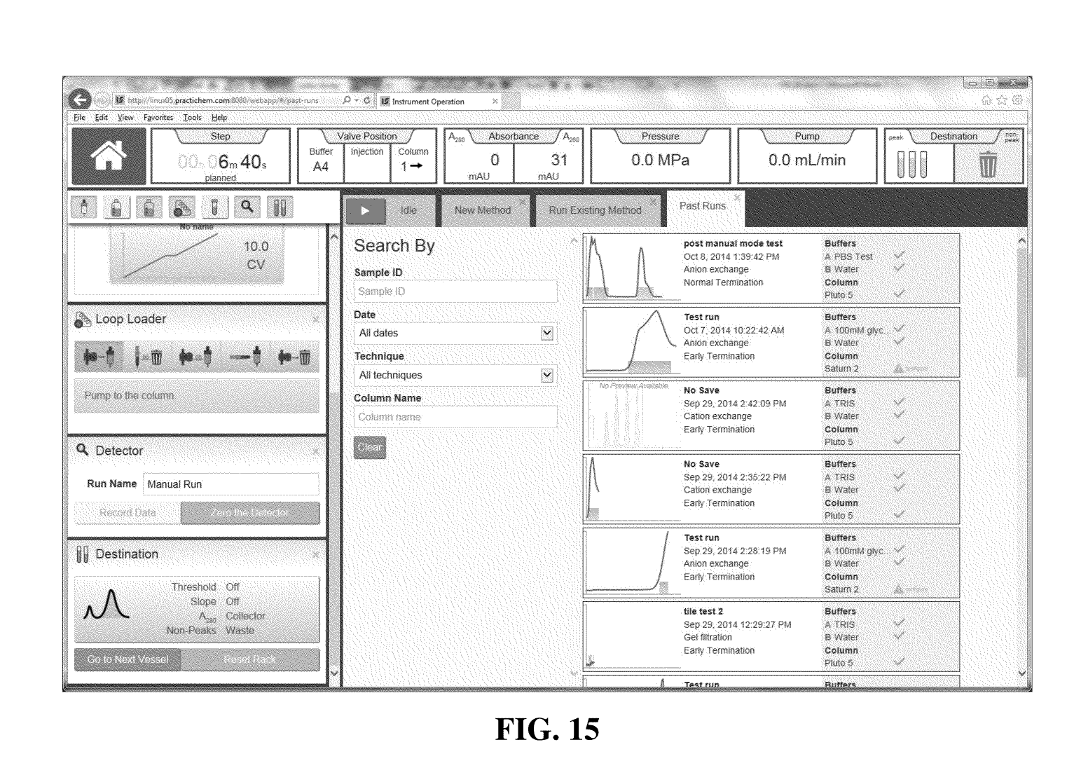

FIG. 15 shows a detector and destination screen.

### Detector

Here, the user selects a name to store detector data. The user may also recalibrate the zero point of the detector.

### Destination

The user sets peak detection parameters here. The user may also choose to set the next vessel to fill as the next vessel or the first vessel in the rack.

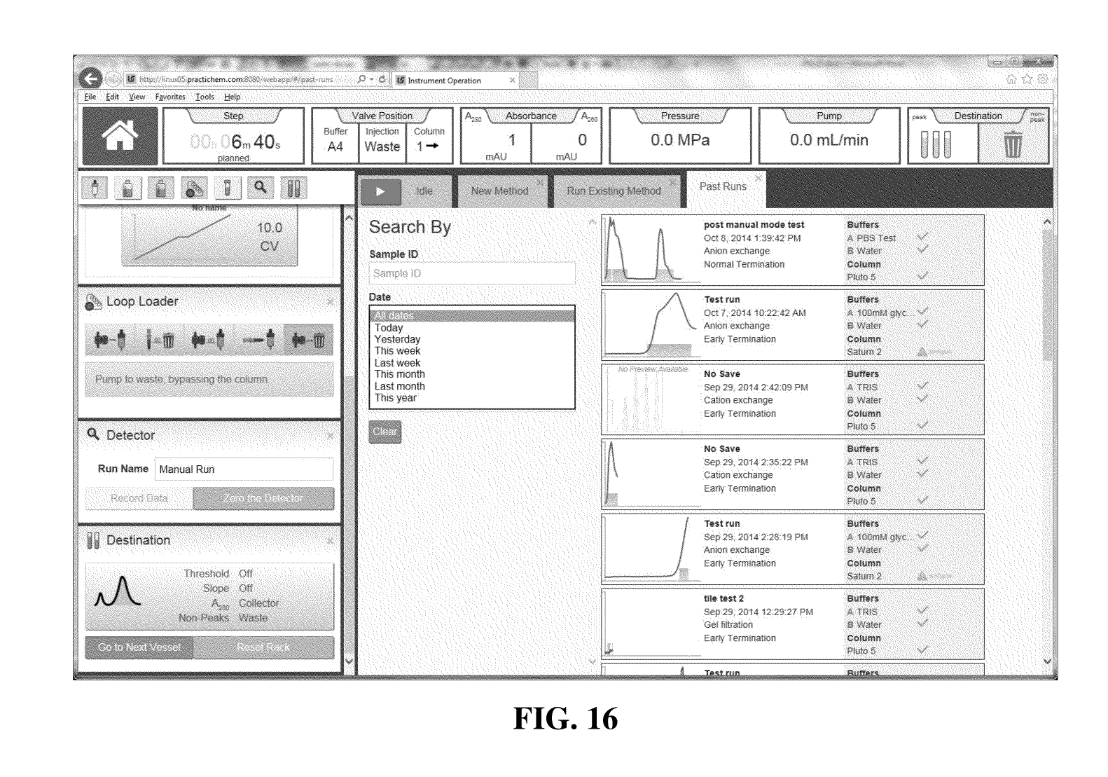

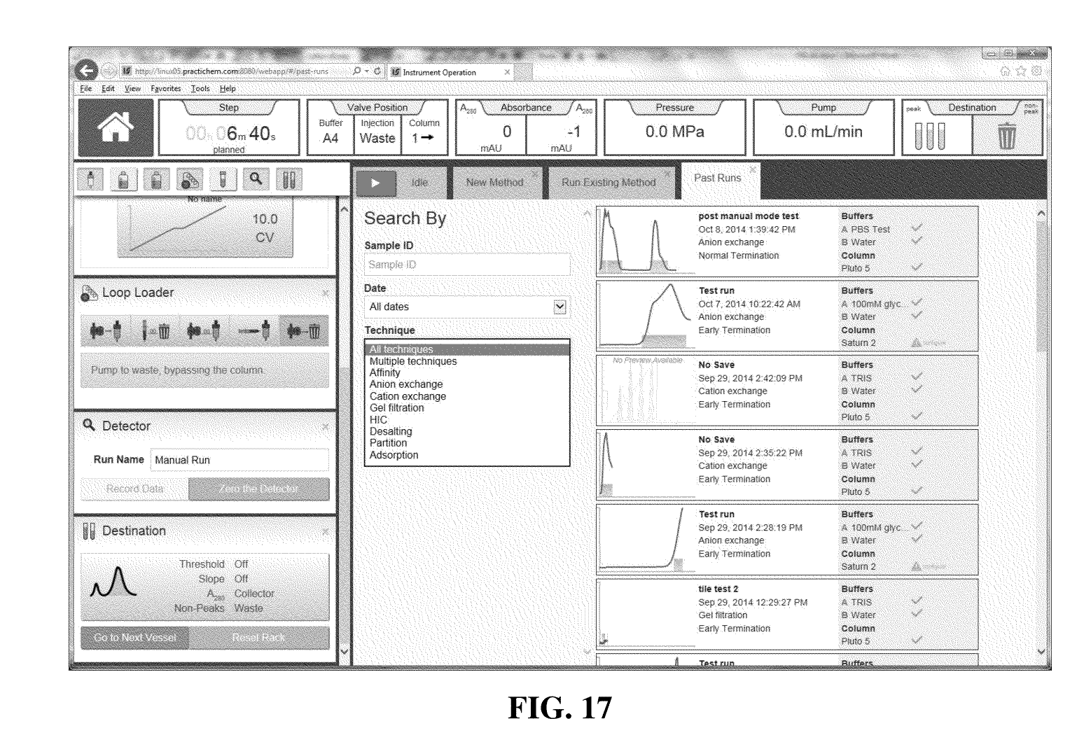

FIG. 16 and FIG. 17 are past run screens that show examples of past run search criteria.

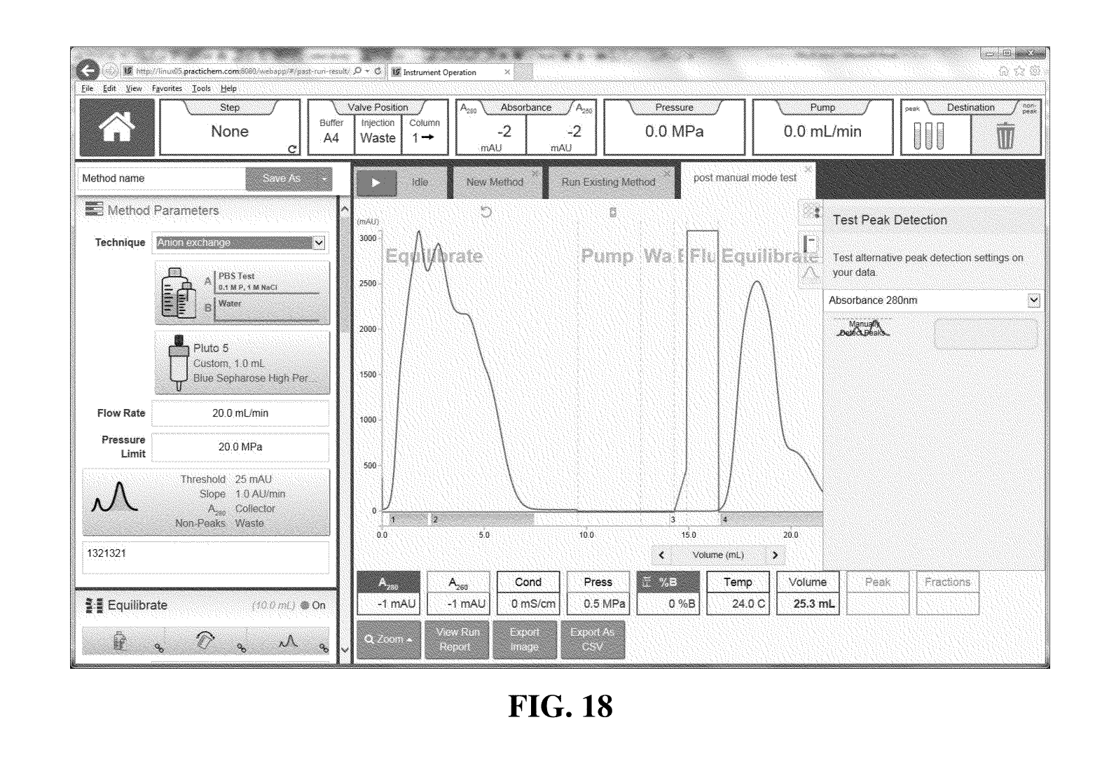

FIG. 18 is a screen that shows many elements.

### Current Value Tiles

The current value tiles (ex. A280) show the value displayed under the graphical cursor. If the cursor is not positioned on the graph, these tiles show the latest (right-most) value. The tiles can be selected (touch, click, etc.) to perform a particular action. Tiles showing series data (ex: A280, Cond, Press) iterate through modes when selected. Modes can be display/hide, fit to screen/full scale, etc. Other tiles change mode when selected. The Volume tile changes the graph X axis. In this example, it iterates through time, volume and column volumes.

### Action Buttons

These buttons (ex: View Run Report) perform immediate actions associated with the current run or the display of current run data.

### Analysis Tab

On the right, depicted by iconographs of a peak, an array of tubes and a notebook are slide-out tabs. The current tab shows an alternate peak detection algorithm. Users can choose from different analysis components. Sometimes these are prerelease components used for testing. Other times, one component may work better for a particular task.

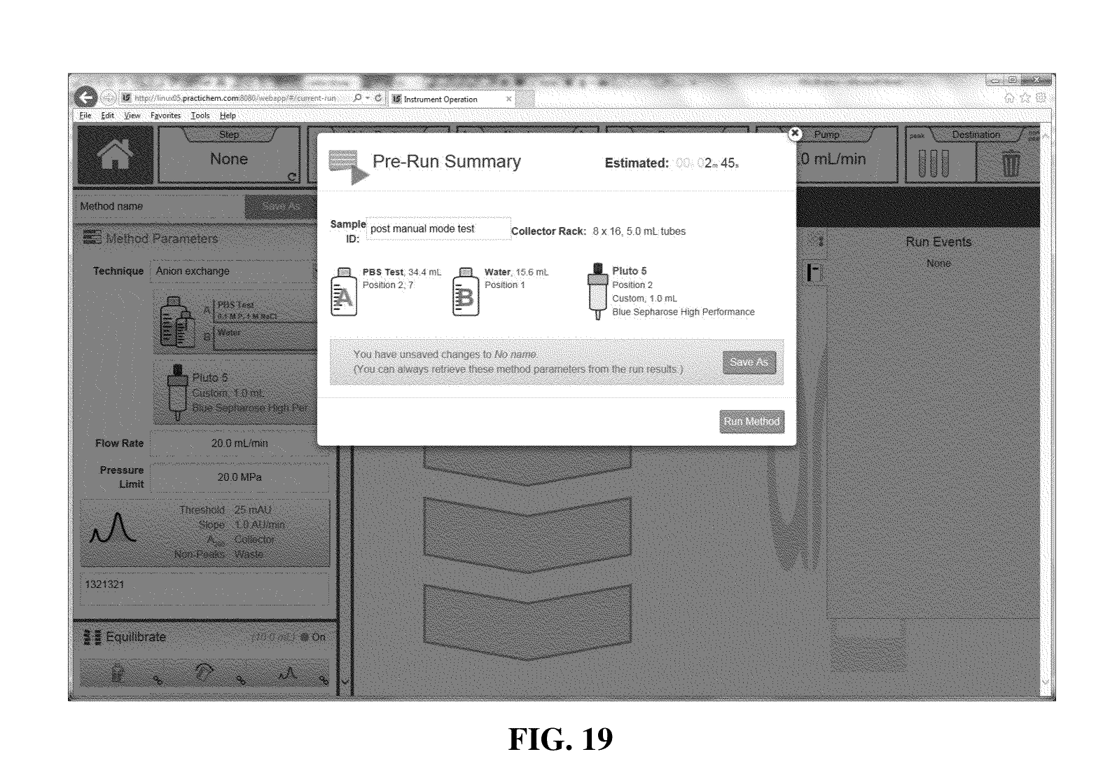

FIG. 19 is a pre-run summary screen, which provides a concise view of important parameters not easily altered once the run begins. This is also where the user first names a particular run (using the Sample ID field). This field can be called other names (run ID, for example). It should also be noted that in the operation of this system, the user need not save changes immediately. The method parameters can be extracted from any past run.

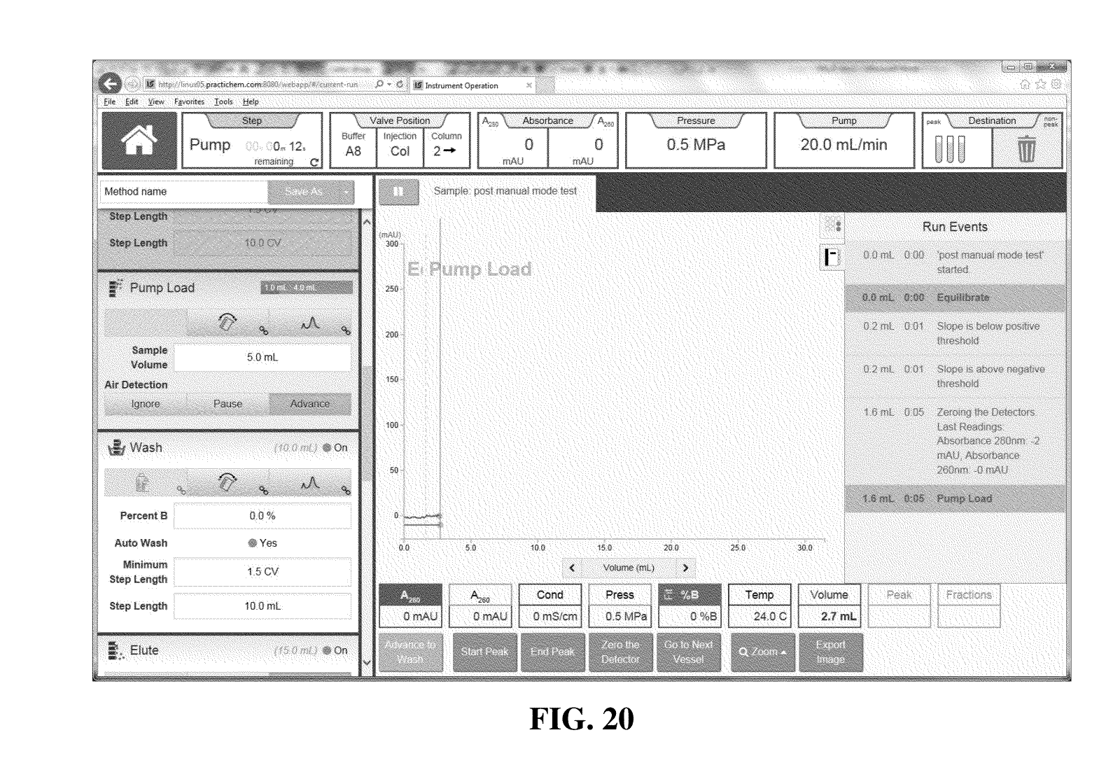

FIG. 20 is a run events screen, in which the analysis tab of FIG. 19 is replaced by the Run Events log. This log is searchable and depicts all significant events related to the displayed run. The events are indexed according to pumped run volume because this is the most linear measure of run progress. Additionally, in this screen display, the method steps are shown for Pump Load and Wash. AutoWash is shown as an example here.

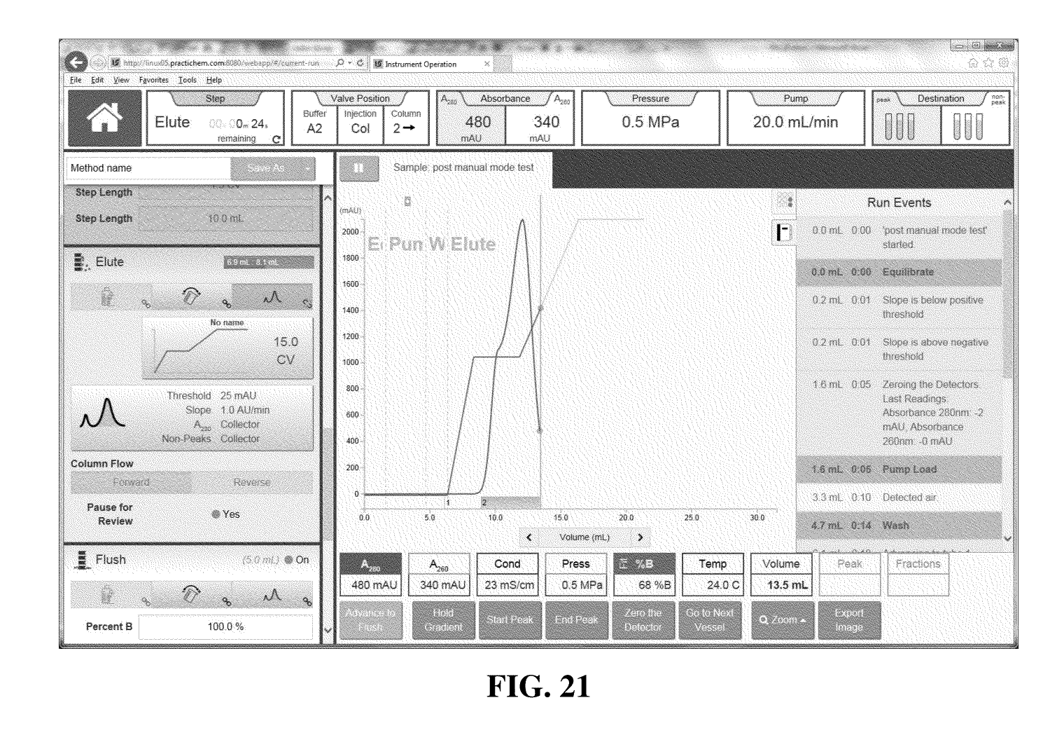

FIG. 21 shows a screen in which a Pause for Review option is displayed in the method panel. Pause for review allows the user to verify the run has completed before the system begins performing unrecoverable actions to make the chromatography column ready for a next use.

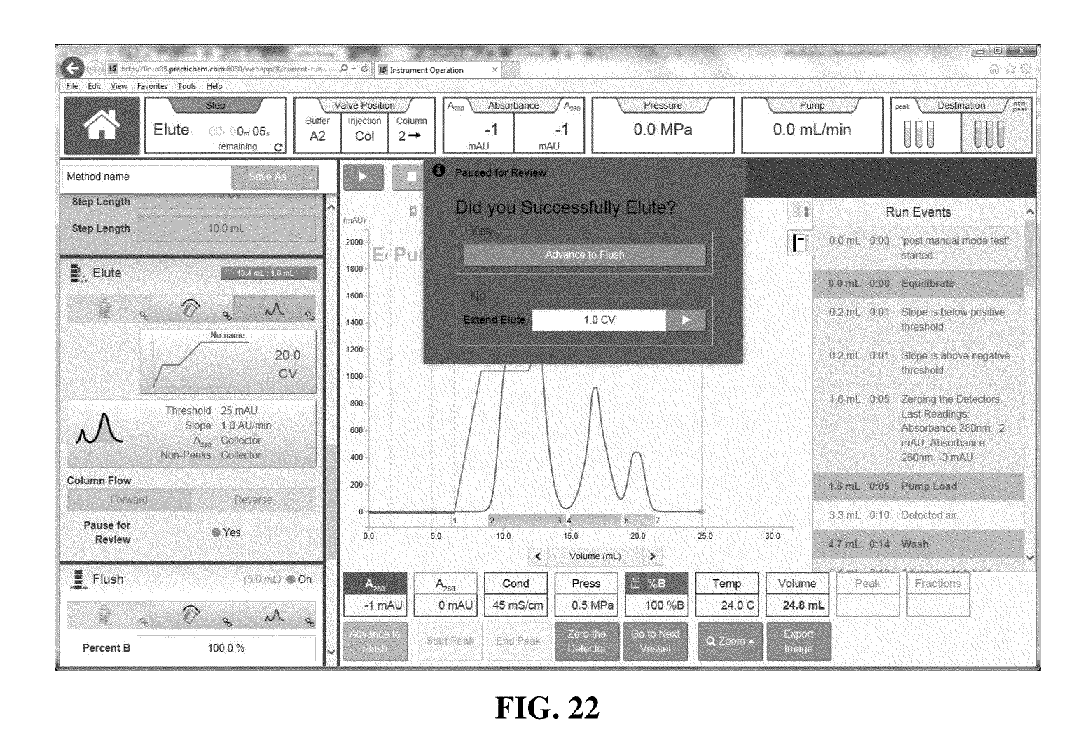

FIG. 22 is a screen showing what the user sees when the system is asked to Pause for Review. The user can choose to continue (assumed the elution completed normally) or can modify the next steps to further elute the user's desired compounds.

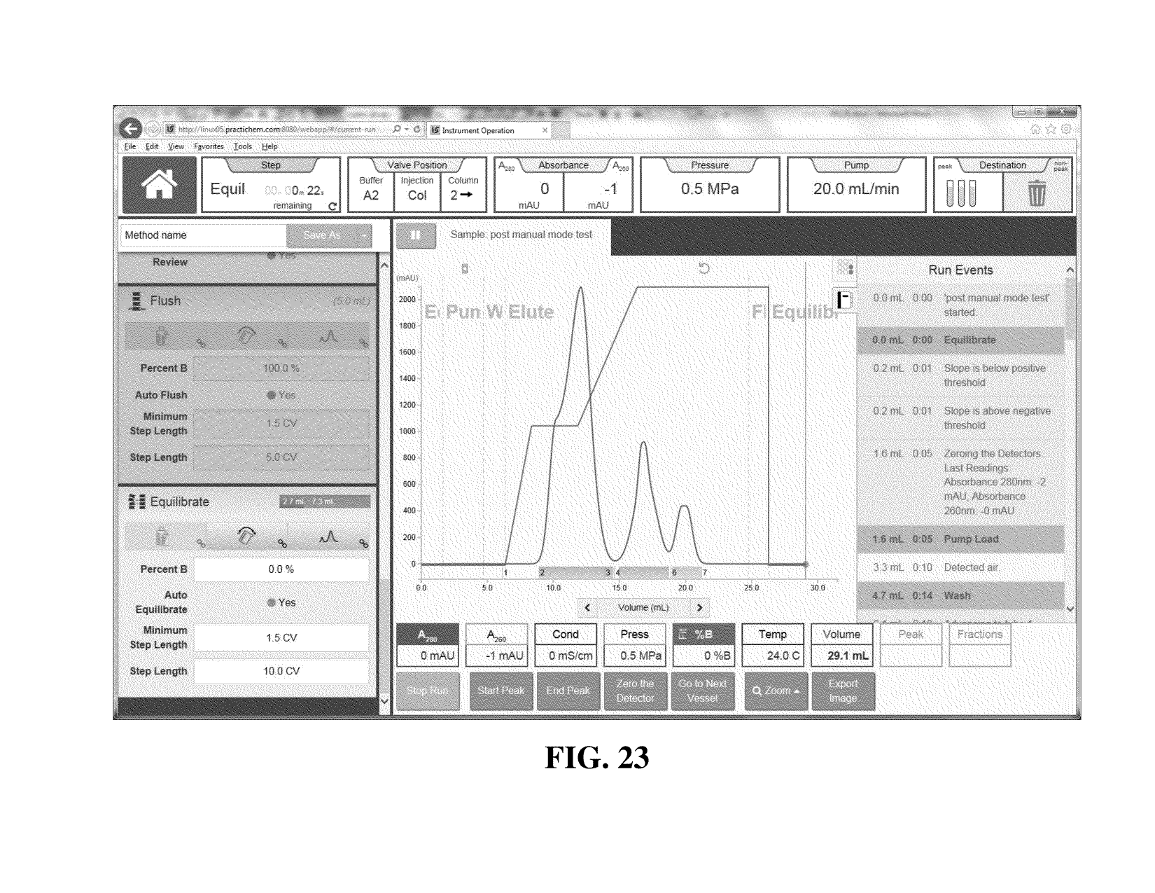

FIG. 23 illustrates a run in progress. Note that method panels are highlighted (gray for the already-executed steps, green for the executing step). This is the currently executing method step. This can be confirmed by viewing the status tiles, where “Equil” is displayed.

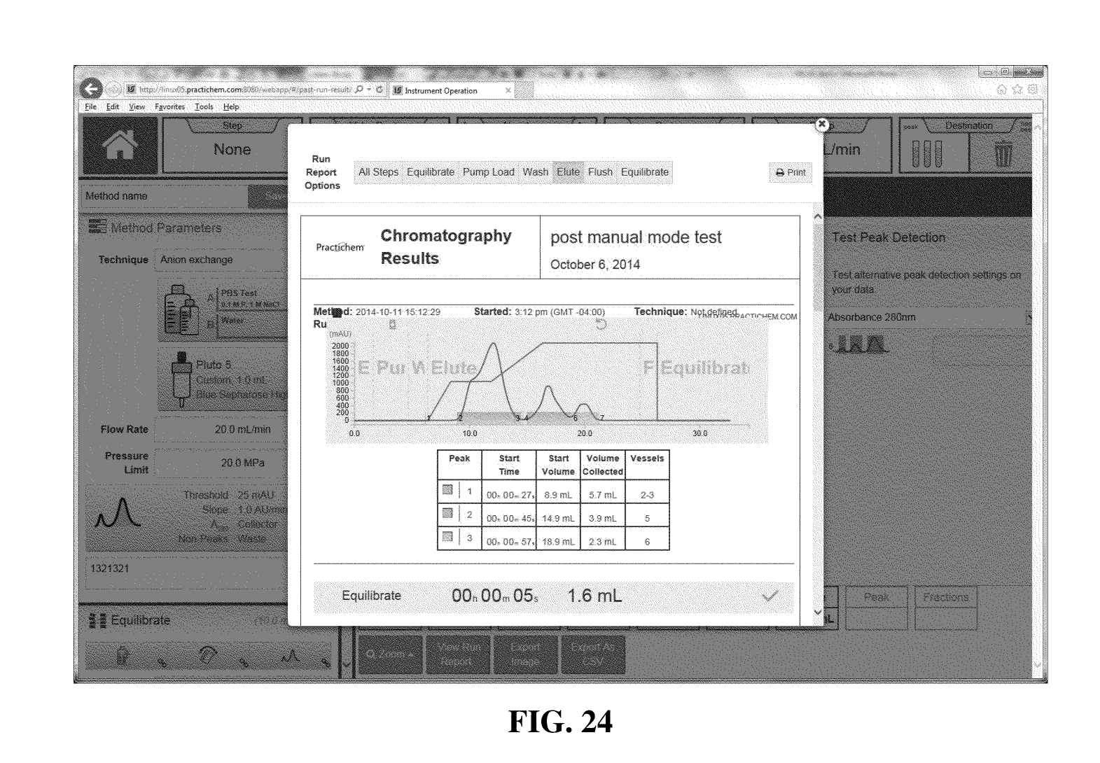

FIG. 24 is a screen showing a run report including a summary and detail of all method steps executed for a particular run. The user may choose to include or exclude certain method steps.

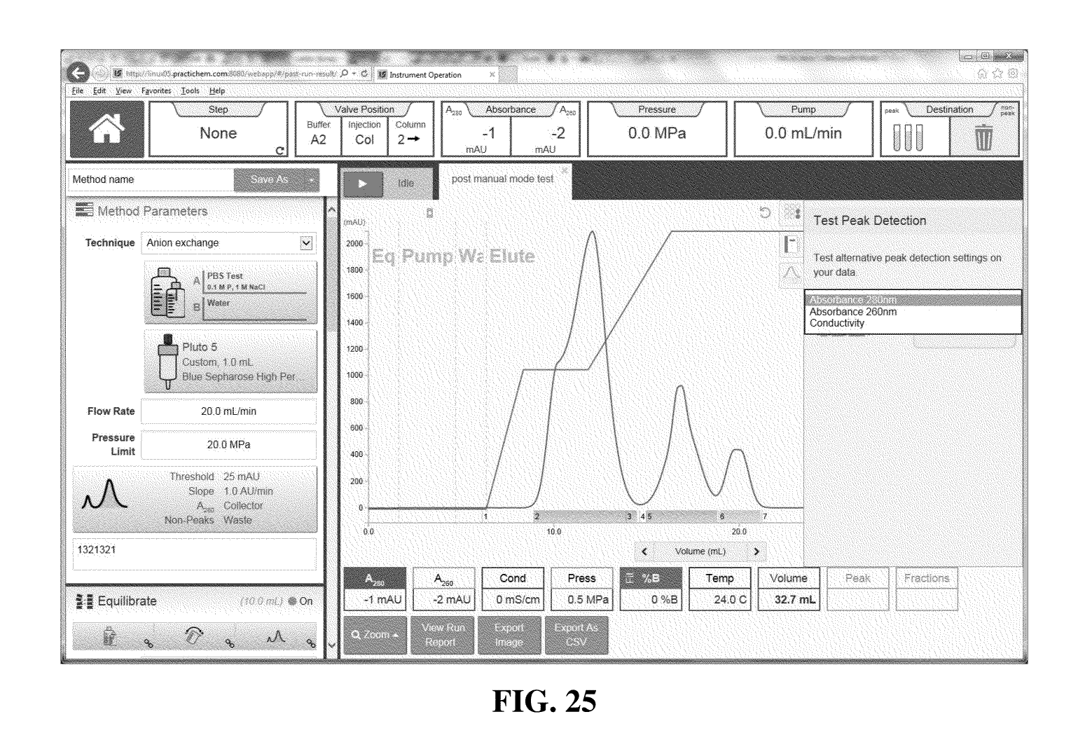

FIGS. 25-29 show examples of alternative peak detection algorithms.

As evidenced by the foregoing, the present disclosure provides high-performance web-based interactive process facilities and systems management apparatus and methods, which have general applicability to industrial facilities and equipment utilized to carry out unit or sequential operations in the specific processing application, and which have particular utility to operation of high performance liquid chromatography equipment and facilities.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A web-based interactive process facilities and systems management apparatus, comprising a server computer including an interface software in electronic communication with a user interface executing on at least one user computer as a web-based application, said electronic communication including communication links configured for linkage to high-performance liquid chromatography (HPLC) process equipment in a process facility for systems management thereof, wherein the apparatus is configured so that information related to the process equipment can be communicated between the interface software, at least one user interface, and process equipment, for operational planning, monitoring, and/or control of high performance liquid chromatography system operations of a high-performance liquid chromatography facility

2. The apparatus of claim 1, wherein the interface software is configured to generate on the user interface status tiles that are user-selectable for display or access of sub-functions thereof to communicate one or more items of the information related to the process equipment, wherein the status tiles are addable or removable by the user on the user interface, wherein the status tiles are manipulatable by a user to configure specific elements in the visualized tiles as display units of the user interface, by animational operations selected from the group consisting of flip, sliding, window shade, and fade operations, and wherein the status tiles are configured to be user-interactive in character, so that a click or touch of the tile generates a response selected from the group consisting of: alteration of the tile view, initiation of an operational mode of the process equipment, toggling between operational modes of pausing and resuming, and resetting an operational motor status of the process equipment.

3. The apparatus of claim 2, wherein the status tiles are configured to depict status or one or more conditions associated with or relevant to the process equipment.

4. The apparatus of claim 1, wherein the interface software is configured for data reduction capability of chromatogram displays as a data management tool enabling efficient data visualization, wherein the interface software is configured to resample a complete data set exceeding a number of pixels allocated for display on the user interface, and to responsively generate a resampled data set for visualization on the user interface in a view that is matched to the number of pixels allocated for display on the user interface, and wherein the interface software is configured to initiate resampling in response to user alteration of a view.

5. The apparatus of claim 4, wherein the user alteration of a view that initiates resampling by the interface software, comprises zooming or panning

6. The apparatus of claim 4, wherein the interface software is configured for data reduction capability so that retrieved database data is cached in memory, wherein the interface software is configured to dynamically reduce data by identification of most important data points for transmission to the user interface, and wherein the interface software is configured to identify as the most important data points for transmission to the user interface data embodying a predetermined level of greatest change.

7. The apparatus of claim 6, wherein the interface software is configured to display a chromatogram for the process equipment comprising an HPLC unit, wherein the chromatogram is user-zoomable in character on the user interface, and the interface software is configured to identify which data components during zooming operation are relevant to a new view, and to display corresponding detail of the chromatogram on the user interface, wherein the interface software is configured to at least one of (i) responsively actuate status tiles in response to user input related to the chromatogram, wherein the status tiles are manipulable by a user to set view properties of a data series related to the user input, and (ii) display on status tiles current values of collected and processed data and/or selected point(s) or region(s) of the chromatogram.

8. The apparatus of claim 6, wherein the interface software is configured to display a chromatogram for the process equipment comprising an HPLC unit, wherein the chromatogram is user-zoomable in character on the user interface, and the interface software is configured to display a sub-view window and an overview window for respective zoomed and un-zoomed views, and wherein the sub-view window and overview window are bidirectionally associated so that sub-view and overview modes can be selectively transitioned to one another in a repetitive and reversible manner.

9. The apparatus of claim 6, wherein the interface software is configured to display a chromatogram for the process equipment comprising an HPLC unit, wherein the chromatogram is user-pannable in character on the user interface, and the interface software is configured to identify which data components during panning operation are relevant to a new view, and to display corresponding detail of the chromatogram on the user interface.

10. The apparatus of claim 1, wherein the interface software is configured to display information on regions of the user interface, wherein said user interface regions correspond to steps or events in a process of the process equipment, wherein the user interface regions correspond to events in a process of the process equipment, and the interface software is configured to label the events with a watermark label, and wherein the interface software is configured to cause the label to slide proportionally across a display on the user interface as the display is panned.

11. The apparatus of claim 1, wherein the interface software is configured to display information of method programs of operation of the process equipment that are modifiable by user selection on the user interface, and at least one of (i)-(iv):
(i) the method programs of operation of the process equipment are modifiable by addition, removal, or disabling of method program steps thereof, wherein the interface software is configured so that removal of method program steps effects movement of the removed steps to a common collection locus from which they are subsequently returnable to a same or different method program without loss of step data;
(ii) the interface software is configured to display information for steps of a method program on status tiles displayed on the user interface;
(iii) the interface software is configured to display draggable nodes on the user interface that are manipulable by a user to effect change in one or more steps of the method program; and
(iv) the interface software is configured to enable user tagging or favoriting of method program steps or elements thereof for selection and employment in later process equipment operations.

12. The apparatus of claim 1, wherein the server computer comprises a queryable database and the interface software is configured to enable user retrieval of an importance-ordered list of information from the database for user review and selection of resources for process equipment operation, wherein the database comprises method programs of operation of the process equipment, wherein the interface software is configured to display on the user interface a pre-run summary for subsequent operation of the process equipment, to enable user verification of resources for successful execution of the subsequent operation of the process equipment, wherein the interface software is configured to include in the pre-run summary operational parameters for verification that the subsequent operation will be conducted successfully.

13. The apparatus of claim 1, wherein the interface software is configured for: user reversal of process equipment performance actions; pausing of process equipment operation; user stoppage of process equipment operation; generating a split data set that is not readily combinable, in response to in-process alteration of the operation of the process equipment; and simultaneous connection of multiple web browsers of corresponding user computers to the server computer, so that multiple users can simultaneously view the user interface and control the process equipment in real time.

14. The apparatus of claim 1, wherein the interface software is configured to: provide real-time assistance capability on the user interface; display availability status of a potential helper user on the user interface, and enable a user requiring assistance to contact an available helper user and secure real-time assistance; provide a chat link for said contact; and provide permission controls for said contact.

15. The apparatus of claim 1, wherein the high performance liquid chromatography equipment includes an onboard server computing platform comprising microprocessor, RAM, persistent storage, and networking connections.

16. The apparatus of claim 15, wherein the onboard server computing platform is connected directly or indirectly to at least one other instrument component selected from the group consisting of pumps, valves, liquid handlers, and sensors.

17. The apparatus of claim 15, characterized by any one or more of (i) to (iv):
(i) operating software controlling instrument logic is contained in the persistent storage;
(ii) the at least one instrument is configured to store instrument data comprising method programs and results log files, in the persistent storage;
(iii) the apparatus comprises multiple instruments, wherein instrument data of one of said multiple instruments is stored by the onboard server computing platform of another one of said multiple instruments; and
(iv) the apparatus comprises multiple instruments, wherein the multiple instruments are mesh networked with one another.

18. The apparatus of claim 1, wherein the interface software is configured for linking functionality of operating parameters of the process equipment, wherein when linked, each parameter follows a master parameter and the parameter's entry controls are removed from view on the user interface, wherein the master parameter's value is displayed in a linking control, wherein the linking control displays a link state on the user interface, and wherein the linking control is configured to allow user unlinking of a parameter, and wherein upon such unlinking, the parameter's entry controls appear, taking on an editable default value.

19. The apparatus of claim 1, wherein the interface software is configured to display a quantity editor on the user interface, wherein the quantity editor is configured to convert inputted numerical values of units to numerical values of other units for operation of the process equipment, wherein the quantity editor is configured to calculate upper and lower range limits of the numerical values, and/or to provide valid limits guidance for appropriate user entry of numerical values of units for operation of the process equipment.

20. The apparatus of claim 1, wherein the interface software is configured for multi-data stream monitoring capability for operation of the process equipment, wherein the interface software is configured to display prognostic performance indicators for operation of the process equipment, and retrospective performance indicators upon completion of an operation of the process equipment, and wherein the process equipment further comprises a mobile phase supply assembly including multiple sources of fluids arranged for delivery to a high performance liquid chromatography unit of the high performance liquid chromatography equipment, and a variable volume mixer configured to receive fluids from the multiple sources of fluids and to form a homogeneous mobile phase mixture therefrom for delivery to the high performance liquid chromatography unit.
